(19) United States
(12) Patent Application Publication
(10) Pub. No.: US 2019/0197620 A1
(43) Pub. Date: Jun. 27, 2019

(54) FINANCIAL SETTLEMENT SYSTEMS AND METHODS

(71) Applicant: Baton Systems, Inc., Fremont, CA (US)

(72) Inventors: Arjun Jayaram, Fremont, CA (US); Mohammad Taha Abidi, San Ramon, CA (US)

(21) Appl. No.: 16/226,458

(22) Filed: Dec. 19, 2018

Related U.S. Application Data
(60) Provisional application No. 62/607,858, filed on Dec. 19, 2017.

(51) Int. Cl. G06Q 40/04; G06F 16/27

(52) U.S. Cl. CPC G06Q 40/04; G06F 16/27

(57) ABSTRACT

Example financial settlement systems and methods are described. In one implementation, a financial management system identifies multiple trades between parties in a common network. The financial management system also identifies settlement rules associated with the common network and displays the multiple trades to the parties in the common network. Additionally, the financial management system receives an approval or dispute associated with at least one of the multiple trades from at least one party. The financial management system determines whether the received approval or dispute complies with the settlement rules and implements the received approval or dispute if it complies with the settlement rules.

### RELATED APPLICATIONS

This application claims the priority benefit of U.S. Provisional Application Ser. No. 62/607,858, entitled “Financial Settlement Systems and Methods,” filed on Dec. 19, 2017, the disclosure of which is hereby incorporated by reference herein in its entirety.

### TECHNICAL FIELD

The present disclosure relates to financial systems and, more particularly, to systems and methods that manage financial settlements.

### BACKGROUND

Various financial systems are used to transfer assets between different organizations, such as financial institutions. For example, in existing systems, each financial institution maintains a ledger to keep track of accounts at the financial institution and transactions associated with those accounts. Financial institutions generally cannot access the ledger of another financial institution. Thus, a particular financial institution can only see part of a financial transaction (i.e., the part of the transaction associated with that financial institution's accounts). When executing critical asset transfers, it is important that all parties to the transfer can see the details of the transfer. Further, when interacting with multiple financial institutions, it is important to maintain consistent rules for settling financial transactions.

### BRIEF DESCRIPTION OF THE DRAWINGS

Non-limiting and non-exhaustive embodiments of the present disclosure are described with reference to the following figures, wherein like reference numerals refer to like parts throughout the various figures unless otherwise specified.

FIG. 1 is a block diagram illustrating an environment within which an example embodiment may be implemented.

FIG. 2 is a block diagram illustrating an embodiment of a financial management system configured to communicate with multiple other systems.

FIG. 3 illustrates an embodiment of an example asset transfer between two financial institutions.

FIG. 4 illustrates an embodiment of a method for transferring assets between two financial institutions.

FIG. 5 illustrates an embodiment of a method for authenticating a client and validating a transaction.

FIG. 6 is a block diagram illustrating an embodiment of a financial management system interacting with an API server and an audit server.

FIG. 7 illustrates an example arrangement of multiple accounts and account structures.

FIG. 8 illustrates an example environment within which the described systems and methods may be implemented.

FIG. 9 illustrates example payment queues showing the processing of various payments.

FIG. 10 illustrates an example of node properties.

FIG. 11 illustrates an embodiment of a user interface display that presents upcoming settlements.

FIG. 12 illustrates an embodiment of a user interface display that provides information regarding trades with a particular counterparty.

FIGS. 13A and 13B illustrate an embodiment of user interface displays that present trades that are part of the settlement cycles.

FIG. 14 illustrates an embodiment of a method for settling trades between multiple parties.

FIG. 15 illustrates an embodiment of a user interface display that presents settings for all member banks.

FIG. 16 illustrates an embodiment of a user interface display that presents various settlements available for approval or rejection.

FIG. 17 illustrates an example state diagram showing various states that a transaction may pass through.

FIG. 18 is a block diagram illustrating an embodiment of a financial management system interacting with a cryptographic service and multiple client nodes.

FIG. 19 is a block diagram illustrating an example computing device.

### DETAILED DESCRIPTION

It will be readily understood that the components of the present systems and methods, as generally described and illustrated in the figures herein, could be arranged and designed in a wide variety of different configurations. The following detailed description of the embodiments of the financial settlement systems and methods is not intended to limit the scope of the invention, as claimed, but is merely representative of certain examples of presently contemplated embodiments in accordance with the invention.

Existing financial institutions typically maintain account information and asset transfer details in a ledger at the financial institution. The ledgers at different financial institutions do not communicate with one another and often use different data storage formats or protocols. Thus, each financial institution can only access its own ledger and cannot see data in another financial institution's ledger, even if the two financial institutions implemented a common asset transfer.

The systems and methods described herein enable institutions to move assets on demand by enabling authorized users to execute complex workflows. Additionally, the described systems and methods allow one or more 3rd parties to view and confirm payment activities between participants. Further, the systems and methods support the synchronization of data, such as transaction data, across multiple ledgers. In some embodiments, the multiple ledgers are heterogeneous ledgers. In other situations, the multiple ledgers are non-heterogeneous ledgers. The systems and methods described herein are capable of on-demand settlements across multiple ledgers. Additionally, the systems and methods discussed herein are operable with DLT (Distributed Ledger Technology) systems and non-DLT systems. In some examples discussed herein, the systems and methods are discussed with respect to one or more financial institutions. However, the described systems and methods are applicable to any type of system associated with any entity. The described systems and methods are not limited to use with financial institutions.

As discussed herein, distributed ledger technology (DLT) is a database or other data storage mechanism that is spread across multiple systems or sites, such as different institutions and/or different geographic areas.

As used herein, a workflow describes, for example, the sequence of activities associated with a particular transaction, such as an asset transfer. In particular, the systems and methods provide a clearing and settlement gateway between, for example, multiple financial institutions. When a workflow is executed, the system generates and issues clearing and settlement messages (or instructions) to facilitate the movement of assets. A shared permissioned ledger (discussed herein) keeps track of the asset movement and provides visibility to the principals and observers in substantially real time. The integrity of these systems and methods is important because the systems are dealing with core payments that are a critical part of banking operations. Additionally, many asset movements are final and irreversible. Therefore, the authenticity of the request and the accuracy of the instructions are crucial. Further, reconciliation of transactions between multiple parties are important to the management of financial data.

As discussed herein, payments between parties can be performed using multiple asset types, including currencies, treasuries, securities (e.g., notes, bonds, bills, and equities), and the like. Payments can be made for different reasons, such as margin movements, collateral pledging, swaps, delivery, fees, liquidation proceeds, and the like. As discussed herein, each payment may be associated with one or more metadata.

As used herein, DCC refers to a direct clearing client or an individual or institution that owes an obligation. A payee refers to an individual or institution that is owed an obligation. A CCG (or Guarantor) refers to a client clearing guarantor or an institution that guarantees the payment of an obligation. A CCP refers to a central counterparty clearinghouse and a Client is a customer of the FCM (Futures Clearing Merchant)/CCG guarantor. Collateral settlements refer to non-cash based assets that are cleared and settled between CCP, FCM/CCG guarantor, and DCC. CSW refers to collateral substitution workflow, which is a workflow used for the pledging and recall (including substitution) of collateral for cash. A clearing group refers to a logical grouping of stakeholders who are members of that clearing group that are involved in the clearing and settlement of one or more asset types. A workflow, when executed, facilitates a sequence of clearing and settlement instructions between members of a clearing group as specified by the workflow parameters.

When some financial transactions change state (e.g., initiated—pending—approved—cleared—settled, etc.) it may trigger one or more notifications to the principals involved in the transaction. The systems and methods described herein provide multiple ways to receive and respond to these notifications. In some embodiments, these notifications can be viewed and acknowledged using a dashboard associated with the described systems and methods or using one or more APIs.

As used herein, principals refer to the parties that are directly involved in a payment or transaction origination or termination. An observer refers to a party that is not a principal, but may be a stakeholder in a transaction. In some embodiments, an observer can subscribe for a subset of notifications generated by the systems and methods discussed herein. In some situations, one or more principals may need to agree that the observer can receive the subset of notifications. APIs refer to an application program interface that allow other systems and devices to integrate with the systems and methods described herein.

The systems and methods described herein provide a payment platform that enables the movement of assets between principals. The platform also provides real time visibility into the funds flow with the use of a shared ledger (e.g., a shared, permissioned, and replicated ledger). Using the shared ledger, users can generate reports on the asset movements and status of the workflows.

In capital markets, the asset movement is triggered due to a settlement on a set of trades between principals. All parties involved in the trade as well as the clearing and settlement of the trade need to perform post trade activities that include reconciliation and regulatory reporting of the trades as well as the payments associated with the trades. Reconciliation and regulatory reporting is a significant pain point for operations teams since it is mostly manual and labor intensive. The main problems related to reconciliation and the regulatory reporting are the heterogeneous systems that are involved in the trade data and the payments. The systems and methods described herein provide a platform to move the assets as part of settlement. These systems and methods can extend this to capture the trade-level information that resulted in the asset movement (settlement). When this functionality is extended to participants on the platform, the reconciliation efforts can be minimized as participants can use the shared and permissioned features of the shared ledger to generate the reconciliation and regulatory reports.

The number of trade events that happen in a day is 3 to 5 orders of magnitude higher than the number of settlements that happen in a day. The data ingestion platform should be able to capture all of the trade events. By extending a data ingestion engine and integrating it with the payments, the systems and methods described herein are able to tie the settlements to the trades. This simplifies the reconciliation and regulatory reporting problems experienced by institutions, users, and the like.

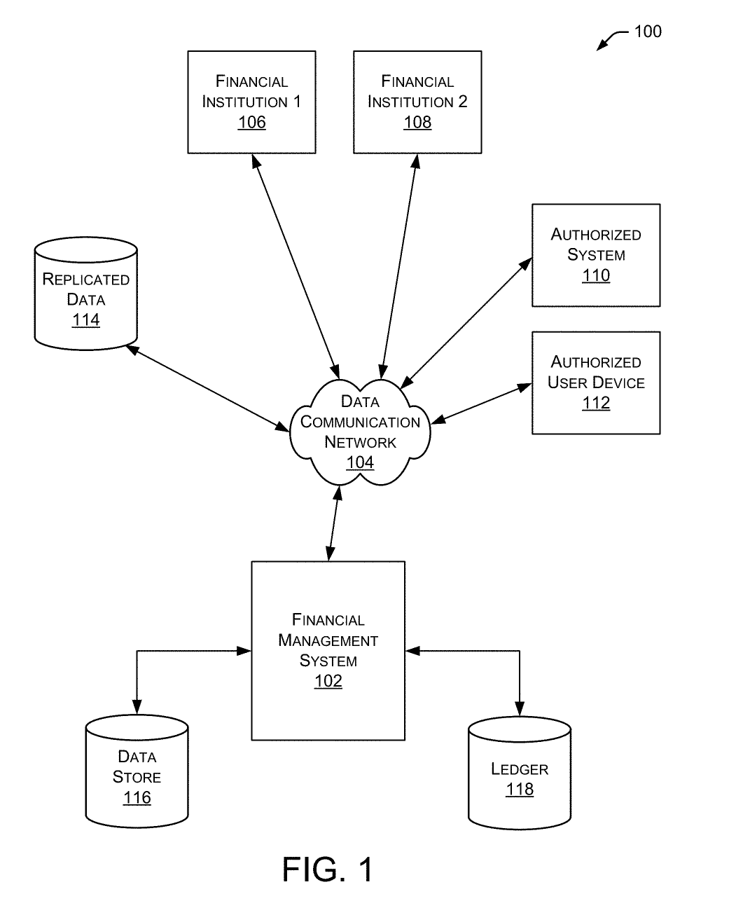

FIG. 1 is a block diagram illustrating an environment 100 within which an example embodiment may be implemented. A financial management system 102 is coupled to a data communication network 104 and communicates with one or more other systems, such as financial institutions 106, 108, an authorized system 110, an authorized user device 112, and a replicated data store 114. As discussed in greater detail herein, financial management system 102 performs a variety of operations, such as facilitating the transfer of assets between multiple financial institutions or other entities, systems, or devices. Although many asset transfers include the use of a central bank to clear and settle the funds, the central bank is not shown in FIG. 1. A central bank provides financial services for a country's government and commercial banking system. In the United States, the central bank is the Federal Reserve Bank. In some implementations, financial management system 102 provides an on-demand gateway integrated into the heterogeneous core ledgers of financial institutions (e.g., banks) to view funds and clear and settle all asset classes. Additionally, financial management system 102 may efficiently settle funds using existing services such as FedWire.

In some embodiments, data communication network 104 includes any type of network, such as a local area network, a wide area network, the Internet, a cellular communication network, or any combination of two or more communication networks. The described systems and methods can use any communication protocol supported by a financial institution's ledger and other systems. For example, the communication protocol may include SWIFT MT (Society for Worldwide Interbank Financial Telecommunication Message Type) messages (such as MT 2XX, 5XX, 9XX), ISO 20022 (a standard for electronic data interchange between financial institutions), and proprietary application interfaces exposed by particular financial institutions. Financial institutions 106, 108 include banks, exchanges, hedge funds, and any other type of financial entity or system. In some embodiments, financial management system 102 interacts with financial institutions 106, 108 using existing APIs and other protocols already being used by financial institutions 106, 108, thereby allowing financial management system 102 to interact with existing financial institutions without significant modification to the financial institution's systems. Authorized system 110 and authorized user device 112 include any type of system, device, or component that is authorized to communicate with financial management system 102. Replicated data store 114 stores any type of data accessible by any number of systems and devices, such as the systems and devices described herein. In some embodiments, replicated data store 114 stores immutable and auditable forms of transaction data between financial institutions. The immutable data cannot be deleted or modified. In particular implementations, replicated data store 114 is an append only data store which keeps track of all intermediate states of the transactions. Additional metadata may be stored along with the transaction data for referencing information available in external systems. In specific embodiments, replicated data store 114 may be contained within a financial institution or other system.

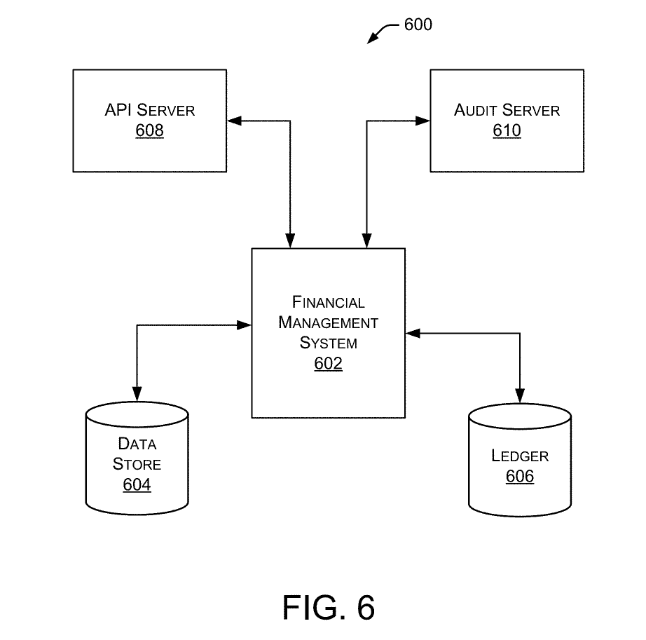

As shown in FIG. 1, financial management system 102 is also coupled to a data store 116 and a ledger 118. In some embodiments, data store 116 is configured to store data used during the operation of financial management system 102. Ledger 118 stores data associated with multiple financial transactions, such as asset transfers between two financial institutions. As discussed herein, ledger 118 is constructed in a manner that tracks when a transaction was initiated and who initiated the transaction. Thus, ledger 118 can track all transactions and generate an audit trail, as discussed herein. Using an audit server of the type described with respect to FIG. 6, financial management system 102 can support audit trails from both the financial management system and external systems and devices. In some embodiments, each transaction entry in ledger 118 records a client identifier, a hash of the transaction, an initiator of the transaction, and a time of the transaction. This data is useful in auditing the transaction data.

In some embodiments, ledger 118 is modeled after double-entry accounting systems where each transaction has two entries (i.e., one entry for each of the principals to the transaction). The entries in ledger 118 include data related to the principal parties to the transaction, a transaction date, a transaction amount, a transaction state, any relevant workflow reference, a transaction ID, and any additional metadata to associate the transactions with one or more external systems. The entries in ledger 118 also include cryptographic hashes to provide tamper resistance and auditability. Users for each of the principals to the transaction only have access to their own entries (i.e., the transactions to which the principal was a party). Access to the entries in ledger 118 can be further restricted or controlled based on a user's role or a party's role, where certain data is only available to certain roles.

In some embodiments, ledger 118 is a shared ledger that can be accessed by multiple financial institutions and other systems and devices. In particular implementations, both parties to a specific transaction can access all details related to that transaction stored in ledger 118. All details related to the transaction include, for example, the parties involved in the transaction, the type of transaction, the date and time of the transaction, the amount of the transaction, and other data associated with the transaction. Additionally, ledger 118 restricts permission to access specific transaction details based on relevant trades associated with a particular party. For example, if a specific party (such as a financial institution or other entity) requests access to data in ledger 118, that party can only access (or view) data associated with transactions to which the party was involved. Thus, a specific party cannot see data associated with transactions that are associated with other parties and do not include the specific party.

The shared permission aspects of ledger 118 provides for a subset of the ledger data to be replicated at various client nodes and other systems. The financial management systems and methods discussed herein allow selective replication of data. Thus, principals, financial institutions, and other entities do not have to hold data for transactions to which they were not a party.

It will be appreciated that the embodiment of FIG. 1 is given by way of example only. Other embodiments may include fewer or additional components without departing from the scope of the disclosure. Additionally, illustrated components may be combined or included within other components without limitation. In some embodiments, financial management system 102 may also be referred to as a “financial management platform,” “financial transaction system,” “financial transaction platform,” “asset management system,” or “asset management platform.”

In some embodiments, financial management system 102 interacts with authorized systems and authorized users. The authorized set of systems and users often reside outside the jurisdiction of financial management system 102. Typically, interactions with these systems and users are performed via secured channels. To ensure the integrity of financial management system 102, various constructs are used to provide system/platform integrity as well as data integrity.

In some embodiments, system/platform integrity is provided by using authorized (e.g., whitelisted) machines and devices, and verifying the identity of each machine using security certificates, cryptographic keys, and the like. In certain implementations, particular API access points are determined to ensure that a specific communication originates from a known enterprise or system. Additionally, the systems and methods described herein maintain a set of authorized users and roles, which may include actual users, systems, devices, or applications that are authorized to interact with financial management system 102. System/platform integrity is also provided through the use of secure channels to communicate between financial management system 102 and external systems. In some embodiments, communication between financial management system 102 and external systems is performed using highly secure TLS (Transport Layer Security) with well-established handshakes between financial management system 102 and the external systems. Particular implementations may use dedicated virtual private clouds (VPCs) for communication between financial management system 102 and any external systems. Dedicated VPCs offer clients the ability to set up their own security and rules for accessing financial management system 102. In some situations, an external system or user may use the DirectConnect network service for better service-level agreements and security.

In some embodiments financial management system 102 allows each client to configure and leverage their own authentication systems. This allows clients to set their custom policies on user identity verification (including 2FA (two factor authentication)) and account verification. An authentication layer in file management system 102 delegates requests to client systems and allows the financial management system to communicate with multiple client authentication mechanisms.

Financial management system 102 also supports role-based access control of workflows and the actions associated with workflows. Example workflows may include Payment vs Payment (PVP) and Delivery vs Payment (DVP) workflows. In some embodiments, users can customize a workflow to add their own custom steps to integrate with external systems that can trigger a change in transaction state or associate them with manual steps. Additionally, system developers can develop custom workflows to support new business processes. In particular implementations, some of the actions performed by a workflow can be manual approvals, a SWIFT message request/response, scheduled or time-based actions, and the like. In some embodiments, roles can be assigned to particular users and access control lists can be applied to roles. An access control list controls access to actions and operations on entities within a network. This approach provides a hierarchical way of assigning privileges to users. A set of roles also includes roles related to replication of data, which allows financial management system 102 to identify what data can be replicated and who is the authorized user to be receiving the data at an external system.

In some embodiments, financial management system 102 detects and records all client metadata, which creates an audit trail for the client metadata. Additionally, one or more rules identify anomalies which may trigger a manual intervention by a user or principal to resolve the issue. Example anomalies include system request patterns that are not expected, such as a high number of failed login attempts, password resets, invalid certificates, volume of requests, excessive timeouts, http errors, and the like. Anomalies may also include data request patterns that are not expected, such as first time use of an account number, significantly larger than normal amount of payments being requested, attempts to move funds from an account just added, and the like. When an anomaly is triggered, financial management system 102 is capable of taking a set of actions. The set of actions may initially be limited to pausing the action, notifying the principals of the anomaly, and only resuming activity upon approval from a principal.

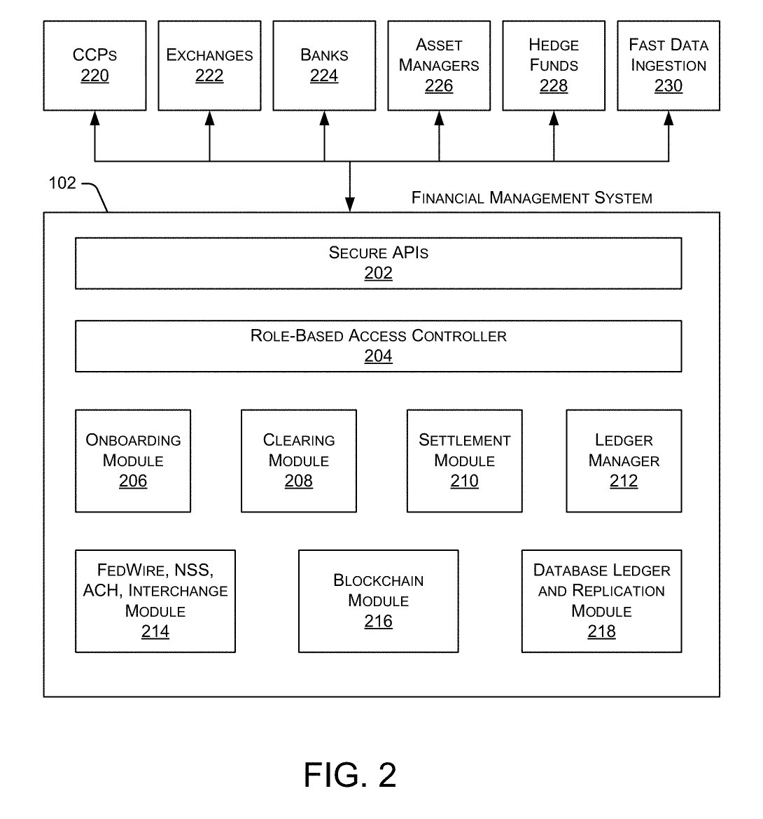

FIG. 2 is a block diagram illustrating an embodiment of financial management system 102 configured to communicate with multiple other systems. As shown in FIG. 2, financial management system 102 may be configured to communicate with one or more CCPs (Central Counterpart Clearing Houses) 220, one or more exchanges 222, one or more banks 224, one or more asset managers 226, one or more hedge funds 228, and one or more fast data ingestion systems (or “pipes”) 230. CCPs 220 are organizations that facilitate trading in various financial markets. Exchanges 222 are marketplaces in which securities, commodities, derivatives, and other financial instruments are traded. Banks 224 include any type of bank, credit union, savings and loan, or other financial institution. Asset managers 226 include asset management organizations, asset management systems, and the like. In addition to hedge funds 228, financial management system 102 may also be configured to communicate with other types of funds, such as mutual funds. Financial management system 102 may communicate with CCPs 220, exchanges 222, banks 224, asset managers 226, and hedge funds 228 using any type of communication network and any communication protocol. Fast data ingestion systems 230 include at least one data ingestion platform that consumes trades in real-time along with associated events and related metadata. The platform is a high throughput pipe which provides an ability to ingest trade data in multiple formats. The trade data are normalized to a canonical format, which is used by downstream engines like matching, netting, real-time counts, and liquidity projections and optimizers. The platform also provides access to information in real-time to different parties of the trade. In some embodiments, fast data ingestion systems 230 may include one or more data ingestion engines. Additional details regarding the data ingestion engines and the data ingestion process are provided herein.

Financial management system 102 includes secure APIs 202 that are used by partners to securely communicate with financial management system 102. In some embodiments, the APIs are stateless to allow for automatic scaling and load balancing. Role-based access controller 204 provide access to modules, data and activities based on the roles of an individual user or participant interacting with financial management system 102. In some embodiments, users belong to roles that are given permissions to perform certain actions. An API request may be checked against the role to determine whether the user has proper permissions to perform an action. An onboarding module 206 includes all of the metadata associated with a particular financial institution, such as bank account information, user information, roles, permissions, clearing groups, assets, and supported workflows. A clearing module 208 includes, for example, a service that provides the functionality to transfer assets between accounts within a financial institution. A settlement module 210 monitors and manages the settlement of funds or other types of assets associated with one or more transactions handled by financial management system 102.

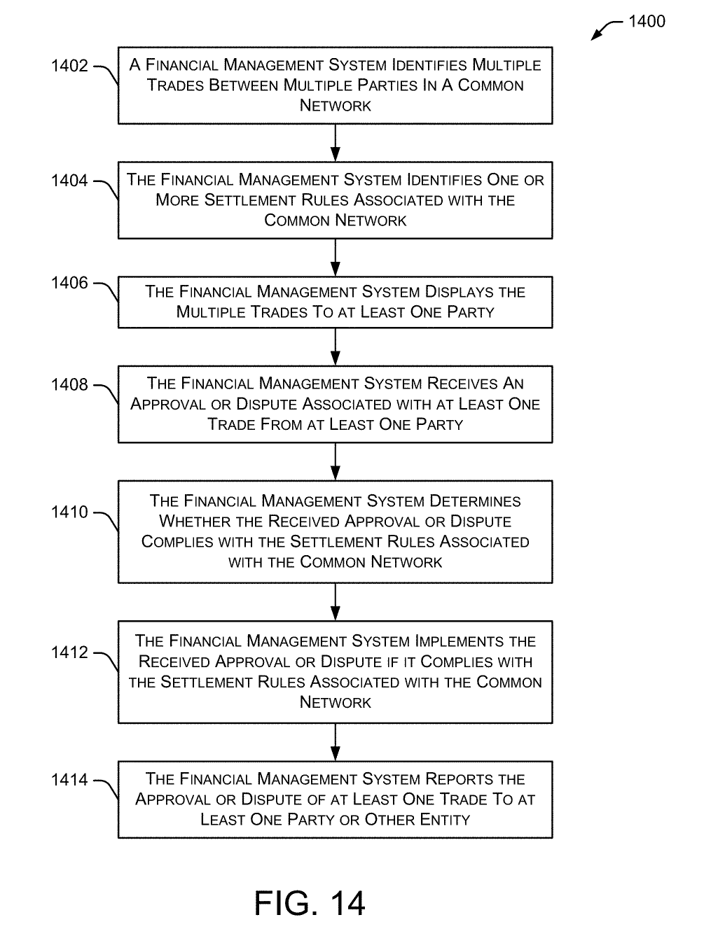

Financial management system 102 also includes a ledger manager 212 that manages a ledger (e.g., ledger 118 in FIG. 1) as discussed herein. A FedWire, NSS (National Settlement Service), ACH (Automated Clearing House), Interchange module 214 provides a service used to interact with standard protocols like FedWire and ACH for the settlement of funds. A blockchain module 216 provides interoperability with blockchains for settlement of assets on a blockchain . A database ledger and replication module 218 provides a service that exposes constructs of a ledger to the financial management system. Database ledger and replication module 218 provides functionality to store immutable transaction states with the ability to audit them. The transaction data can also be replicated to authorized nodes for which they are either a principal or an observer. Although particular components are shown in FIG. 2, alternate embodiments of financial management system 102 may contain additional components not shown in FIG. 2, or may not contain some components shown in FIG. 2. Although not illustrated in FIG. 2, financial management system 102 may contain one or more processors, one or more memory devices, and other components such as those discussed herein with respect to FIG. 14.

In the example of FIG. 2, various modules, components, and systems are shown as being part of financial management system 102. For example, financial management system 102 may be implemented, at least in part, as a cloud-based system. In other examples, financial management system 102 is implemented, at least on part, in one or more data centers. In some embodiments, some of these modules, components, and systems may be stored in (and/or executed by) multiple different systems. For example, certain modules, components, and systems may be stored in (and/or executed by) one or more financial institutions.

As mentioned above, system/platform integrity is important to the secure operation of financial management system 102. This integrity is maintained by ensuring that all actions are initiated by authorized users or systems. Additionally, once an action is initiated and the associated data is created, an audit trail of any changes made, and other information related to the action is recorded for future reference.

In particular embodiments, financial management system 102 includes (or interacts with) a roles database and an authentication layer. The roles database stores various roles of the type discussed herein.

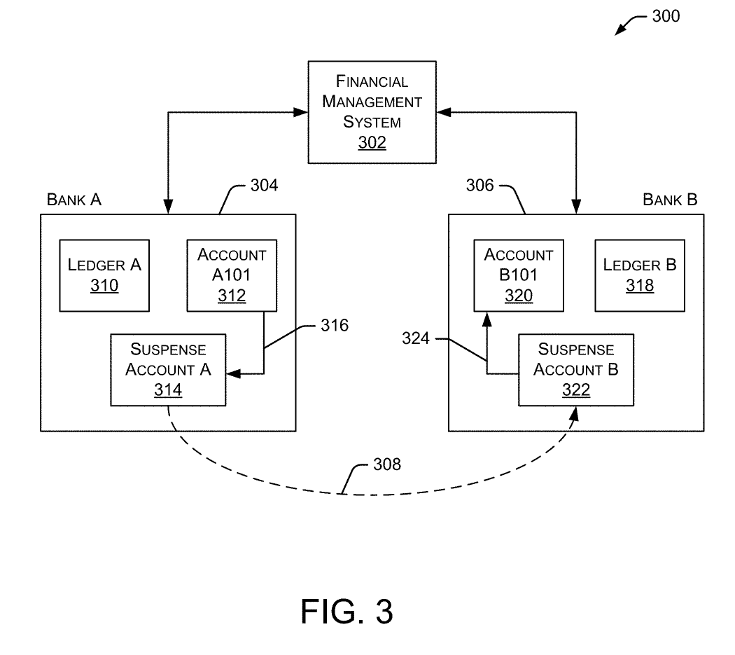

FIG. 3 illustrates an embodiment 300 of an example asset transfer between two financial institutions. In the example of FIG. 3, financial management system 302 is in communication with a first bank 304 and a second bank 306. In this example, funds are being transferred from an account at bank 304 to an account at bank 306, as indicated by broken line 308. Bank 304 maintains a ledger 310 that identifies all transactions and data associated with transactions that involve bank 304. Similarly, bank 306 maintains a ledger 318 that identifies all transactions and data associated with transactions that involve bank 306. In some embodiments, ledgers 310 and 318 (or the data associated with ledgers 310 and 318) reside in financial management system 302 as a shared, permissioned ledger, such as ledger 118 discussed above with respect to FIG. 1.

In the example of FIG. 3, funds are being transferred out of an account 312 at bank 304. To facilitate the transfer of funds out of account 312, the funds being transferred are moved 316 from account 312 to a first suspense account 314 at bank 304. Each suspense account discussed herein is a “For Benefit Of” (FBO) account and is operated by the financial management system for the members of the network (i.e., all parties and principals). The financial management system may facilitate the transfer of assets into and out of the suspense accounts. However, the financial management system does not take ownership of the assets in the suspense accounts. The credits and debits associated with each suspense account are issued by the financial management system and the ledger (e.g., ledger 118 in FIG. 1) is used to track ownership of the funds in the suspense accounts. Each suspense account has associated governance rules that define how the suspense account operates. At bank 306, the transferred funds are received by a second suspense account 322. The funds are moved 324 from second suspense account 322 to an account 320 at bank 306. In some embodiments, a suspense account may be referred to as a settlement account.

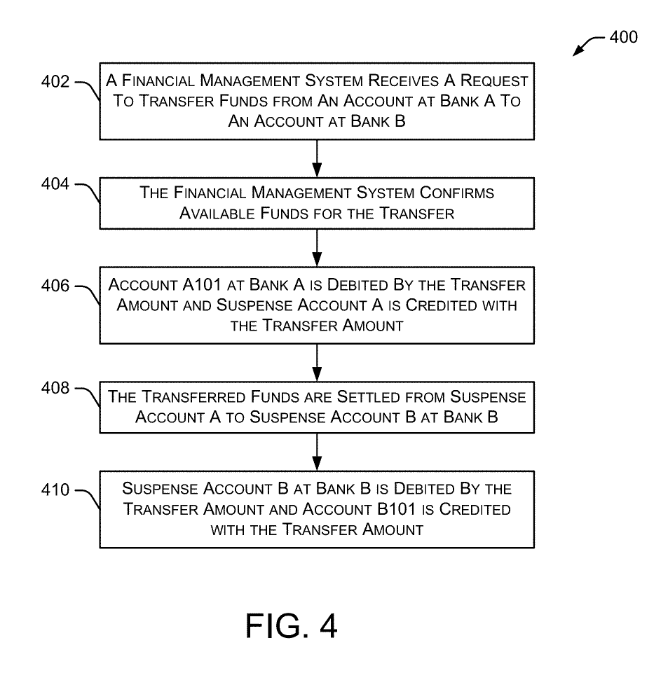

As discussed herein, financial management system 302 facilitates the transfer of funds between bank 304 and 306. Additional details regarding the manner in which the funds are transferred are provided below with respect to FIG. 4. Although only one account and one suspense account is shown for each bank in FIG. 3, particular embodiments of bank 304 and 306 may contain any number of accounts and suspense accounts. Additionally, bank 304 and 306 may contain any number of ledgers and other systems. In some embodiments, each suspense account 314, 322 is established as part of the financial institution “onboarding” process with the financial management system. For example, the financial management system administrators may work with financial institutions to establish suspense accounts that can interact with the financial management system as described herein.

In some embodiments, one or more components discussed herein are contained in a traditional infrastructure of a bank or other financial institution. For example, an HSM (Hardware Security Module) in a bank may execute software or contain hardware components that interact with a financial management system to facilitate the various methods and systems discussed herein. In some embodiments, the HSM provides security signatures and other authentication mechanisms to authenticate participants of a transaction.

FIG. 4 illustrates an embodiment of a method 400 for transferring assets (e.g., funds) between two financial institutions. Initially, a financial management system receives 402 a request to transfer funds from an account at Bank A to an account at Bank B. The request may be received by Bank A, Bank B, or another financial institution, system, device, and the like. Using the example of FIG. 3, financial management system 302 receives a request to transfer funds from account 312 at bank 304 to account 320 at bank 306.

Method 400 continues as the financial management system confirms 404 available funds for the transfer. For example, financial management system 302 in FIG. 3 may confirm that account 312 at bank 304 contains sufficient funds to satisfy the amount of funds defined in the received transfer request. In some embodiments, if available funds are confirmed at 404, the financial management system creates suspense account A at Bank A and creates suspense account B at Bank B. In particular implementations, suspense account A and suspense account B are temporary suspense accounts created for a particular transfer of funds. In other implementations, suspense account A and suspense account B are temporary suspense accounts but are used for a period of time (or for a number of transactions) to support transfers between bank A and bank B.

If available funds are confirmed at 404, then account A 101 at Bank A is debited 406 by the transfer amount and suspense account A (at Bank A) is credited with the transfer amount. Using the example of FIG. 3, financial management system 302 debits the transfer amount from account 312 and credits that transfer amount to suspense account 314. In some embodiments, ownership of the transferred assets changes as soon as the transfer amount is credited to suspense account 314.

The transferred funds are then settled 408 from suspense account A (at Bank A) to suspense account B (at Bank B). For example, financial management system 302 in FIG. 3 may settle funds from suspense account 314 in bank 304 to suspense account 322 in bank 306. The settlement of funds between two suspense accounts is determined by the counterparty rules set up between the two financial institutions involved in the transfer of funds. For example, a counterparty may choose to settle at the top of the hour or at a certain threshold to manage risk exposure. The settlement process may be determined by the asset type, the financial institution pair, and/or the type of transaction. In some embodiments, transactions can be configured to settle in gross or net. For gross transaction settlement of a PVP workflow, the settlement occurs instantaneously over existing protocols supported by financial institutions, such as FedWire, NSS, and the like. Netted transactions may also settle over existing protocols based on counterparty and netting rules. In some embodiments, the funds are settled after each funds transfer. In other embodiments, the funds are settled periodically, such as once an hour or once a day. Thus, rather than settling the two suspense accounts after each funds transfer between two financial institutions, the suspense accounts are settled after multiple transfers that occur over a period of time. Alternatively, some embodiments settle the two suspense accounts when the amount due to one financial institution exceeds a threshold value.

Method 400 continues as suspense account B (at Bank B) is debited 410 by the transfer amount and account B 101 at Bank B is credited with the transfer amount. For example, financial management system 302 in FIG. 3 may debit suspense account 322 and credit account 320. After finishing step 410, the funds transfer from account 312 at bank 304 to account 320 at bank 306 is complete.

In some embodiments, the financial management system facilitates (or initiates) the debit, credit, and settlement activities (as discussed with respect to FIG. 4) by sending appropriate instructions to Bank A and/or Bank B. The appropriate bank then performs the instructions to implement at least a portion of method 400. The example of method 400 can be performed with any type of asset. In some embodiments, the asset transfer is a transfer of funds using one or more traditional currencies, such as U.S. Dollars (USD) or Great British Pounds (GBP).

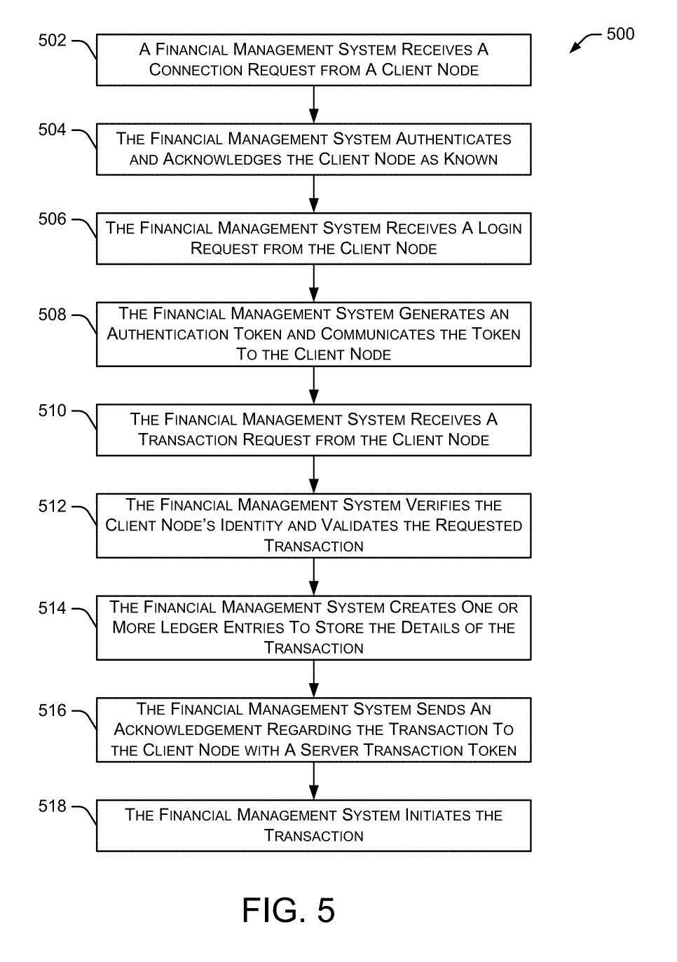

FIG. 5 illustrates an embodiment of a method 500 for authenticating a client and validating a transaction. Initially, a financial management system receives 502 a connection request from a client node, such as a financial institution, an authorized system, an authorized user device, or other client types mentioned herein. The financial management system authenticates 504 and, if authenticated, acknowledges the client node as known. Method 500 continues as the financial management system receives 506 a login request from the client node. In response to the login request, the financial management system generates 508 an authentication token and communicates the authentication token to the client node. In some embodiments, the authentication token is used to determine the identity of the user for future requests, such as fund transfer requests. The identity is then further checked for permissions to the various services or actions.

The financial management system further receives 510 a transaction request from the client node, such as a request to transfer assets between two financial institutions or other entities. In response to the received transaction request, the financial management system verifies 512 the client node's identity and validates the requested transaction. In some embodiments, the client node's identity is validated based on an authentication token, and then permissions are checked to determine if the user has permissions to perform a particular action or transaction. Transfers of assets also involve validating approval of an account by multiple roles to avoid compromising the network. If the client node's identity and requested transaction are verified, the financial management system creates 514 one or more ledger entries to store the details of the transaction. The ledger entries may be stored in a ledger such as ledger 118 discussed herein. The financial management system then sends 516 an acknowledgement regarding the transaction to the client node with a server transaction token. In some embodiments, the server transaction token is used at a future time by the client when conducting audits. Finally, the financial management system initiates 518 the transaction using, for example, the systems and methods discussed herein.

In some embodiments, various constructs are used to ensure data integrity. For example, cryptographic safeguards allow a transaction to span 1-n principals. The financial management system ensures that no other users (other than the principals who are parties to the transaction) can view data in transit. Additionally, no other user should have visibility into the data as it traverses the various channels. In some embodiments, there is a confirmation that a transaction was received completely and correctly. The financial management system also handles failure scenarios, such as loss of connectivity in the middle of the transaction. Any data transmitted to a system or device should be explicitly authorized such that each entry (e.g., ledger entry) can only be seen and read by the principals who were a party to the transaction. Additionally, principals can give permission to regulators and other individuals to view the data selectively.

Cryptographic safeguards are used to detect data tampering in the financial management system and any other systems or devices. Data written to the ledger and any replicated data may be protected by:

Stapling all the events associated with a single transaction.

Providing logical connections of each commit to those that came before it are made.

The logical connections are also immutable, but principals can send messages for relinking. In this case, the current and all preceding links are maintained. For example, trade amendments are quite common. A trade amendment needs to be connected to the original trade. For forensic analysis, a bank may wish to identify all trades by a particular trader. Query characteristics will be graphs, time series, and RDBMS (Relational Database Management System).

In some embodiments, the financial management system monitors for data tampering. If the data store (central data store or replicated data store) is compromised in any way and the data is altered, the financial management system should be able to detect exactly what changed. Specifically, the financial management system should guarantee all participants on the network that their data has not been compromised or changed. Information associated with changes are made available via events such that the events can be sent to principals via messaging or available to view on, for example, a user interface. Regarding data forensics, the financial management system is able to determine that the previous value of an attribute was X, it is now Y and it was changed at time T, by a person A. If a system is hacked or compromised, there may be any number of changes to attribute X and all of those changes are captured by the financial management system, which makes the tampering evident.

In particular embodiments, the financial management system leverages the best security practices for SaaS (Software as a Service) platforms to provide cryptographic safeguards for ensuring integrity of the data. For ensuring data integrity, the handshake between the client and an API server (discussed with respect to FIG. 6) establish a mechanism which allows both the client and the server to verify the authenticity of transactions independently. Additionally, the handshake provides a mechanism for both the client and the server to agree on a state of the ledger. If a disagreement occurs, the ledger can be queried to determine the source of the conflict.

FIG. 6 is a block diagram illustrating an embodiment 600 of a financial management system 602 interacting with an API server 608 and an audit server 610. Financial management system 602 also interacts with a data store 604 and a ledger 606. In some embodiments, data store 604 and ledger 606 are similar to data store 116 and ledger 118 discussed herein with respect to FIG. 1. In particular implementations, API server 608 exposes functionality of financial management system 602, such as APIs that provide reports of transactions and APIs that allow for administration of nodes and counterparties. Audit server 610 periodically polls the ledger to check for data tampering of ledger entries. This check of the ledger is based on, for example, cryptographic hashes and are used to monitor data tampering as described herein.

In some embodiments, all interactions with financial management system 602 or the API server are secured with TLS. API server 608 and audit server 610 may communicate with financial management system 602 using any type of data communication link or data communication network, such as a local area network or the Internet. Although API server 608 and audit server 610 are shown in FIG. 6 as separate components, in some embodiments, API server 608 and/or audit server 610 may be incorporated into financial management system 602. In particular implementations, a single server may perform the functions of API server 608 and audit server 610.

In some embodiments, at startup, a client sends a few checksums it has sent and transaction IDs to API server 608, which can verify the checksums and transaction IDs, and take additional traffic from the client upon verification. In the case of a new client, mutually agreed upon seed data is used at startup. A client request may be accompanied by a client signature and, in some cases, a previous signature sent by the server. The server verifies the client request and the previous server signature to acknowledge the client request. The client persists the last server signature and a random set of server hashes for auditing. Both client and server signatures are saved with requests to help quickly audit correctness of the financial management system ledger. The block size of transactions contained in the request may be determined by the client. A client SDK (Software Development Kit) assists with the client server handshake and embedding on server side signatures. The SDK also persists a configurable amount of server signatures to help with restart and for random audits. Clients can also set appropriate block size for requests depending on their transaction rates. The embedding of previous server signatures in the current client block provides a way to chain requests and provide an easy mechanism to detect tampering. In addition to a client-side signature, the requests are encrypted using standard public key cryptography to provide additional defense against client impersonation. API server 608 logs all encrypted requests from the client. The encrypted requests are used, for example, during data forensics to resolve any disputes.

In particular implementations, a client may communicate a combination of a previous checksum, a current transaction, and a hash of the current transaction to the financial management system. Upon receipt of the information, the financial management system checks the previous checksum and computes a new checksum, and stores the client hash, the current transaction, and the current checksum in a storage device, such as data store 604. The checksum history and hash (discussed herein) protect the integrity of the data. Any modification to an existing row in the ledger cannot be made easily because it would be detected by mismatched checksums in the historical data, thereby making it difficult to alter the data.

The integrity of financial management system 602 is ensured by having server audits at regular intervals. Since financial management system 602 uses chained signatures per client at the financial management system, it ensures that an administrator of financial management system 602 cannot delete or update any entries without making the ledger tamper evident. In some embodiments, the auditing is done at two levels: a minimal level which the SDK enforces using a randomly selected set of server signatures to perform an audit check; and a more thorough audit check run at less frequent intervals to ensure that the data is correct.

In some implementations, financial management system 602 allows for the selective replication of data. This approach allows principals or banks to only hold data for transactions they were a party to, while avoiding storage of other data related to transactions in which they were not involved. Additionally, financial management system 602 does not require clients to maintain a copy of the data associated with their transactions. Clients can request the data to be replicated to them at any time. Clients can verify the authenticity of the data by using the replicated data and comparing the signature the client sent to the financial management system with the request.

In some embodiments, a notarial system is used to maintain auditability and forensics for the core systems. Rather than relying on a single notary hosted by the financial management system, particular embodiments allow the notarial system to be installed and executed on any system that interacts with the financial management system (e.g., financial institutions or clients that facilitate transactions initiated by the financial management system).

The systems and methods discussed herein support different asset classes. Each asset class may have a supporting set of metadata characteristics that are distinct. Additionally, the requests and data may be communicated through multiple “hops” between the originating system and the financial management system. During these hops, data may be augmented (e.g., adding trade positions, account details, and the like) or changed.

In certain types of transactions, such as cash transactions, the financial management system streamlines the workflow by supporting rich metadata accompanying each cash transfer. This rich metadata helps banks tie back cash movements to trades, accounts, and clients.

As discussed herein, the described systems and methods facilitate the movement of assets between principals (also referred to as “participants”). The participants are typically large financial institutions in capital markets that trade multiple financial products. Trades in capital markets can be complex and involve large asset movements (also referred to as “settlements”). The systems and methods described herein can integrate to financial institutions and central settlement authorities such as the US Federal Reserve or DTCC (Depository Trust & Clearing Corporation) to facilitate the final settlement of assets. The described systems and methods also have the ability to execute workflows such as DVP, threshold based settlement, or time-based settlement between participants. Using the workflows, transactions are settled in gross or net amounts.

The systems and methods described herein include a platform and workflow to support and enable 3 rd party guarantors the ability to view payment activity between participants in real time (or substantially real time), and step in to make payments on behalf of participants when necessary.

The ACH (Automated Clearing House) payment service enables companies to electronically collect payments from customers for either one-off or recurring payments by directly debiting a customer's checking or saving accounts. Common uses of ACH include online bill payment, mortgage and loan repayment, and direct deposit of payroll. Also, many investment managers and brokerage firms allow users to link a bank account or an online funding source to a trading account.

Traditionally, connecting directly to bank accounts has been preferred for the following reasons:

1. Lower cost to transfer money using ACH versus paper checks or credit cards

2. Ability to move large amounts of money

3. Fewer instances of fraud from bank accounts compared to credit cards

As used herein, a retail payment is considered a movement of amounts smaller than $100,000 (although this can be any amount). Typically, retail payments in and out of a bank account are settled over settlement venues and protocols such as ACH in the U.S., SEPA (Single Euro Payments Area), NACH in India, etc. These payments have the following advantages:

Low Costs

Ability to schedule automatic payments

Ability to issue a debit pull or credit push

Despite the advantages mentioned above, ACH has the following disadvantages:

Inability to determine the validity of the account (this is possible if the user has closed the bank account at a later point in time)

Inability to determine the balance in the account even if valid (are there sufficient funds to cover the transaction?)

Slow multi-phased settlement protocol that can take hours or even days

Various Reject codes and ability to recall the payments later by the account holder

In some situations, rejections in payments are in the range of 1-10% depending on the type of products that are being purchased. For example, certain types of product purchases (e.g., electronics, jewelry, and the like) are more prone to fraud.

Adding a funding source and moving money

In some situations, online sites and other vendors perform the following steps when linking a bank account.

1. Select a bank from a list of popular retail banks using either of the following:

A. IAV (Instant Account Verification) process. This is done by asking the user to submit the username and password for the bank (or account). The website or process then proceeds to use these credentials to log in on behalf of the user to validate the account. Since the bank credentials are being required by the site, many users are comfortable sharing this information with well reputed companies or financial institutions.

B. Micro Deposits: The website or process follows a multi-step procedure as follows:

i. The user enters the account number and routing number of their banking institution.

ii. The website or process then makes two or more deposits of small amounts, typically less than $0.25, using the account number and routing number.

iii. If the above step fails, the account number and routing number are considered to be incorrect and the user has to return to the beginning of the process to add a funding source. If there is no error, the process proceeds to the next step.

iv. The user comes back to the website or process to complete the addition of the bank account as the funding source by validating the two micro deposit amounts. The fact that the user knew their account number and the routing number, and then was able to accurately validate the two micro deposits is enough proof that the user is indeed the owner of the account. In addition, it also satisfies the BSA (Bank Secrecy Act) requirement for the website or process.

2. Once the bank account has been added as a funding source, the website or process will attempt to debit money from or credit money to the account. Debits are done when the website or process attempts to “pull” money from the account to complete a transaction. Credits are done when the website or process allows the user to “push” money to their bank account. This is done when the website or process has an associated product that allows the user to hold money in their account. This can be for online payments products, brokerage accounts, tax products, auction sites, mortgage or rent payments, and the like.

3. Payments in and out of the bank account can be done as a debit-pull or a credit-push. A debit-pull in the case above is when the company or user attempts to pull a debit from the bank account. A credit-push is when the user authorizes their bank to push funds to a receiver (in this case, the company).

4. In many existing systems, payments are completed over ACH or equivalent methods. The initiator is called the originator of the request. The banking regulations require that the originator be a financial institution and is typically called the ODFI (Originating Depository Financial Institution) and the receiver is called the RDFI (Requesting Depository Financial Institution).

A. In the case of a debit-pull, the ODFI is requesting a debit from the other institution.

B. In the case of a credit-push, the ODFI pushes money to the RDFI.

5. In most cases (but not always), the risk is higher on the ODFI as it is the originator of the request.

Problems with rejections in payments

The steps needed to validate a bank account as a funding source are discussed above, as well as the attempt to do a debit-pull. During the attempt to pull funds, there can be failures which can lead to a direct economic loss for the companies. The following is an illustrative example using an example company brokerage firm ABC-Trading Inc.

1. A customer of ABC Trading adds a bank account as a funding source for their trades and allows ABC Trading to pull and push funds based on their trading activity with the brokerage firm.

2. The customer instructs ABC Trading to buy $5,000 worth of a stock and does not have sufficient balance in their brokerage account to cover the purchase.

3. ABC Trading makes the stock purchase and then must initiate a “pull” of $5,000 from the customer's bank account.

4. ABC Trading initiates a debit-pull by issuing ACH debit instructions to its ODFI. In some cases, ABC Trading may be a bank and can be the ODFI. In other cases, the firm may choose one or more banks where it has a banking relationship to originate the ACH request for them. This can happen on T+0 or T+1 days depending on the cut off time for the ODFI.

5. The ACH debit instructions can be rejected anywhere from T+0 to T+4 days.

6. If at any point, the ACH transfer is rejected, ABC Trading will need to undo the transaction and may be subject to losses if the stock has lost value. There are also operational costs associated with tracking down the funds from the customer.

The steps above may be repeated many thousands of times per day depending on the size of the broker. The process is similar for other companies that offer services such as bill payments, mortgage payments, or online peer-to-peer payment. The firm takes the risk of an unsuccessful debit from point T+0 to T+4 days when the request is complete. The rejections, despite the successful validation of the account, are due to the following:

A. Inability to validate the account at point T+0: It is possible that the account may have been closed by the user. ABC Trading has no information about the closure of the account at point T+0. Following the closure of the account, any attempt to debit the amounts from the account will result in a rejection.

B. Insufficient balance in the account: The account did not have sufficient balance to complete the request. In the example above, the account did not have $ 5000.

C. Other errors: There are several reject codes that NACHA supports.

On demand payments

The systems and methods discussed herein include a hardware and/or software platform that facilitates the movement of assets between principals. In some embodiments, the participants are large financial institutions in capital markets that trade multiple financial products. Trades in capital markets can be complex and involve large asset movements (also referred to as “settlements”). The clearing and settlement gateway discussed herein can integrate to financial institutions and central settlement authorities such as the U.S. Federal Reserve, DTC, and the like to facilitate the final settlement of assets.

In some embodiments, the systems and methods described herein have the following core components:

1. Clearing and Settlement Gateway: This is used to integrate to the core ledgers of the banks and settlement agencies to initiate and execute clearing and settlement.

2. Permissioned Shared Ledger: When an asset is cleared or settled, it goes through several “state changes.” The permissioned shared ledger records the state changes and makes it available to the permissioned parties in substantially real time.

3. Workflows: Parties in a trade can execute complex settlement instructions that determine the sequence of steps that must be followed to effect the movement of assets between participants. The described systems and methods facilitate this with various workflows. In some embodiments, execution of a workflow will result in multiple instructions that are sent and received through the clearing and settlement gateway and multiple records in the permissioned shared ledger.

The payments platform discussed herein provides a practical solution to solve the problems mentioned above.

In some embodiments, the number of funding sources and the amounts of monies moved from these funding sources follows an 80-20 rule. That is, 80% of the money movement happens from 10 or fewer banks. A solution that addresses 80% of the problem will significantly reduce the risks for companies.

The systems and methods described herein describe the components and operation of the data ingestion engine. In particular implementations, the data ingestion engine is able to consume the trades, the events associated with the trade, and the metadata associated with the events. The data ingestion engine is a reliable high throughput pipe with idempotency (e.g., replaying same events should not alter the trade data). The data ingestion engine also supports the ability to ingest data in different formats from different participants. The systems and methods can start with an XML format. It is important that the systems and methods have the ability to normalize the message formats as each principal's data format is likely to be different. Additionally, the data ingestion engine has the ability to execute downstream modules such as matching, real time counts, netting, liquidity projections, liquidity optimizers, anomaly detection, and the like.

In some embodiments, trades have the following characteristics:

1. All parties of the trade (principles, broker-dealers, exchanges, etc.) need to get access the information in near real time.

2. A trade has a life cycle from the point of entry into the system, the execution, the augmentation of the data in the middle and back offices all the way through to the point where the trade is cleared/settled. Sometimes, the trades may be reversed before it is settled. During this lifecycle, trade metadata is being augmented.

3. The parties of the trade as well as the banks that act as the custodians of the assets of the principals follow a protocol of confirmations and affirmations that are similar to an ACK set in a TCP protocol (with the noted difference that these are asynchronous systems).

4. Trades are of different types and the metadata of the trade can change depending on the type of trade. Metadata can be thought of as columns to a row in a csv or fields of attributes in XML or JSON. The Financial Information eXchange (FIX) protocol (and the xml version of it—Fixml) have become standards for the messages to capture the trade metadata between parties.

5. The following can be thought of as a pseudo set theory representation of the problem. There are multiple stages to the problem.

a. Data Ingestion

i. A Node N(i) can trade with parties M(1) . . . M(N) for various products P(1) . . . P(N).

ii. A Trade notation T{(Mi, Ni), Pi} can be used to say that parties Mi and Ni have traded a product Pi.

iii. Partial Trade: It is possible that a trade submitted by Ni to Mi may be executed by Mi in separate batches that aggregate to the whole trade. The examples below show the case of the partial trade and how matching will work in that case.

iv. A trade will result in several events to be recorded by each party of the trade. Each event is associated with a set of attributes. By association, these attributes are associated with the trade. Although these attributes are for the trade T{(Mi, Ni), Pi} , Mi and Ni may not have all the attributes as some attributes may be internal tracking attributes for either Mi or Ni.

v. The data ingestion engine will need to ingest these events and the associated metadata for an event from both Mi and Ni.

b. Matching

i. The systems and methods will identify these attributes by a(1), a(2) . . . a(n). Similar to databases, some of these attributes (or columns) may be primary keys or candidate keys to uniquely identify a trade. Examples of these are counter-party-id, cusip, trade-id, etc.

ii. The systems and methods refer to the E(Tx Mi)=>{a1, a2 . . . an} as the events for trade ‘Tx’ ingested from Mi. Likewise, the systems and methods will also refer to E(Tx, Ni)

iii. A trade is said to be ‘Matched to Trade x’ when all the candidate keys from E(Tx Mi) match those from E(Tx, Ni).

iv. The inverse constitutes to an unmatched trade. That occurs when all the candidate keys of E(Tx, Mi) do not match E(Tx Ni).

c. Settlement Cycles

i. Settling is the act of closing out the obligations between principals of a trade. The settlement is the act that involves the movement of assets. The parties of the trade agree on a point in time in the future to settle the trades. The systems and methods refer to that as the ‘settlement date’.

ii. Note: Not all trades will be settled. Some types of trades are never settled and just roll forward.

iii. Principals may decide to run multiple settlement cycles on a settlement date.

iv. The systems and methods discussed herein support settlement cycles.

d. Netting

i. Trades may need to be settled in net or in gross. One or more of the attributes of the trades E(Tx Mi)=>{a1, a2 . . . an}, will indicate the settlement mode (gross vs net). In addition, the attributes will also include other important fields such as ‘value date’, ‘value amount’, ‘settlement date’, ‘settlement cycle’, and the like.

ii. The act of netting will be the following:

1. Group all the matched trades between parties based on the following join criteria (with an AND clause):

a. Matching counterparty: Mi, Ni

b. Same Settlement Date

c. Same Settlement Cycle

d. Settlement type=‘Netted’

2. Compute the sum of the ‘value amounts for each of the groups. This is the netted amount.

The systems and methods described herein enable a DLT-based settlement platform to access central bank money settlement in RTGS (Real Time Gross Settlement) and support pre-funded settlement functionality. These systems and methods also enable functionality that the renewed RTGS service needs to provide a DLT-based settlement platform to optimize its access to central bank money. The described systems and methods also support variations in settlement finality, handling resolution of member defaults, and handling of erroneous balances and contingency processes.

In some embodiments, financial settlement systems and methods may operate with a network (or group) of parties. These parties may be financial institutions, other entities, individuals, and the like. The network (or group) may contain any number of parties and may be organized by any entity, organization, individual, and the like. For example, a particular network may include multiple financial institutions (e.g., Bank A, Bank B, and Bank C) as well as a settlement agent that assists with settling trades between any of the financial institutions. In particular, the settlement agent may assist with settling trades between Bank A and Bank B, between Bank A and Bank C, and between Bank B and Bank C. A particular network may include any number of financial institutions (and other entities) and any number of settlement agents.

In particular implementations, each network has associated settlement rules and recommendations that are applied to all parties in the network. These settlement rules and recommendations are typically agreed upon by each party in the network before joining (or becoming associated with) the network. In some embodiments, the settlement agent applies (and enforces) the settlement rules and recommendations with all parties in the network. Example settlement rules include collateral funding levels required for different types of trades. The settlement rules may also include, for example, definitions of how trades are settled between the multiple parties in the network, such as how frequently trades are settled between the parties. The settlement rules may further define thresholds associated with collateral levels required for each trade as well as timing of settlements associated with various types of trades. As discussed herein, these trades may be associated with, for example, the purchase or sale of securities.

The settlement rules and recommendations reduce the risk to the parties in the network because all parties are operating under the same rules. As discussed herein, particular trades may be broken into multiple smaller payments as “payparts” (partial payments) that are paid over a period of time. In some embodiments, the time period for payment of the multiple payparts is based on the priority level of the trade, as discussed below.

In some embodiments, a bank node is created (e.g., Acme Bank) that represents a real bank. This bank is integrated with APIs rather than SWIFT messages. For example, Acme Bank may use the following APIs:

Queries: The amount of funds available in one or many collateral account(s), and the minimum balance on one or many collateral accounts.

Operations: Funding an account, defunding of an account, setting the minimum balance on a collateral account, and initiating normal settlement.

Settings: Able to settle from a collateral account (Yes/No), and how settlement from a collateral account works.

In some embodiments, the bank node will have two types of member banks under the bank node: a settlement agent and account holders. For example, the financial management systems discussed herein may be the settlement agent and three other banks—Bank A, Bank B and Bank C—will be member banks. Each member bank will have two accounts within it: a settlement account and a collateral account.

In this example, seven nodes are created as shown in Table 1 below.

TABLE 1

| Node Name | Node Type | Contact Information |
|---|---|---|
| Bank A, Bank B, | Member Bank | Provide a set of name |
| Bank C | | contact information, |
| | | as discussed herein |
| Bank D, Bank E | Non Member banks (For | Same set of contact |
| | these banks, the described | information should be |
| | systems and methods have the | maintained for each |
| | ability to add a member bank | set of nodes |
| | as the correspondent or | |
| | intermediary bank. These | |
| | banks may access the | |
| | settlement system through | |
| | these intermediary banks) | |
| Financial | Settlement Agent | Operated by the |
| Management | | settlement systems |
| System discussed | | |
| herein | | |
| Acme Bank | This is the banking node (The | Same levels of contact |
| | bank should be able to see the | information |
| | accounts of the member | |
| | banks) | |

In this example, a clearing group is created with the members discussed above, as shown in Table 2 below.

TABLE 2

| Node Type | Account Structures |
|---|---|
| Member Banks | Each member bank has a settlement account |
| | and a collateral account |
| Non Member Banks | They do not have an account. However, they |
| | should be able to designate another bank as |
| | their intermediary bank |
| Financial Management | No account for this |
| System discussed | |
| herein | |
| Acme Bank | This is a bank node. This should see the |
| | details of the member banks account details, |
| | as discussed herein |

In the current example, the systems and methods are supporting settlement in a particular currency, such as GBP. The collateral accounts have a few intrinsic properties that will control the operations that can be performed on the accounts, as discussed below.

Minimum Opening Balance: This is the balance that is set by the bank. This is supported in relation to the desired minimum balance and the supplemental balance. The bank must fund at least the minimum opening balance into the account. One of the objectives of this is to monitor the minimum opening balance very closely.

Preferred Opening Balance: This is based on a percentage of the amount of net dollars settled by the bank. For example, a significant cost savings is expected with the pre funding account. Since amounts are netted and further payments are going to go through a liquidity savings mechanism (LSM), the described systems and methods should expect to see, for example, between 1:50 to 1:200 liquidity efficiency.

Supplemental Balance: This is the balance can be maintained over the minimum balance. This can be funded throughout the day by the member banks. In some embodiments, the systems and methods keep track of the following:

Opening Settlement Balance: Balance at the time of the first transfer

Transfers: These are the fundings from this account

Current Settlement Balance: These are the amounts that are in the settlement balance

Reserved Balance: A portion of this balance can be marked as “reserved” at any time. The funds in the reserved balance are typically used exclusively for payments that are marked “priority” or “preferred”. Defunding will not be allowed from this balance until they move money out of the reserved balance into the current settlement balance.

Current Settled Primary Position: Minimum balance and debits or credits out this balance that have been settled is the current settled primary position.

Current Day Pending Primary Position: This is the Current Settled Primary Position and the Pending settlement for the current operating day (12:00:00 AM to 23:59:59 PM).

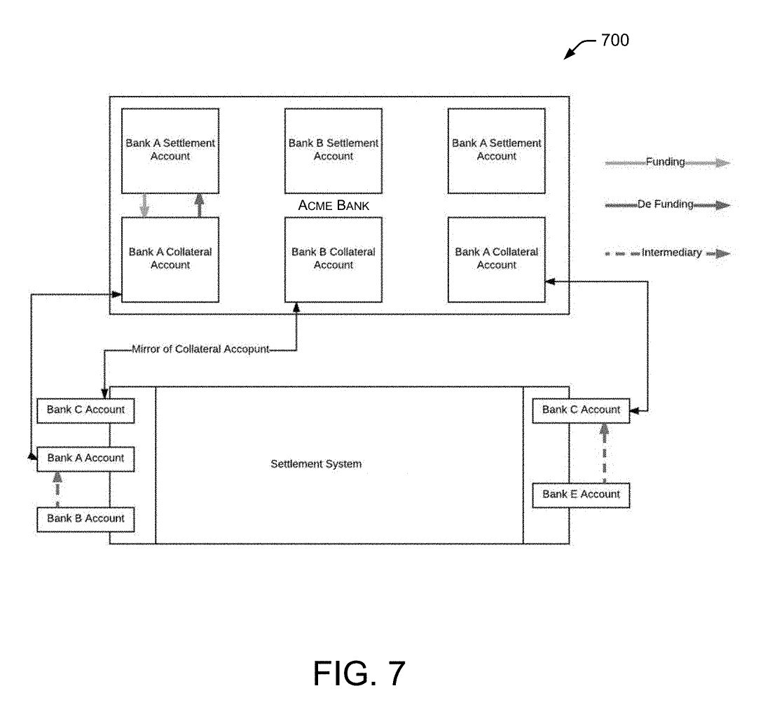

FIG. 7 illustrates an example arrangement 700 of multiple accounts (and account structures) of the type discussed herein. As shown in FIG. 7, the accounts of Bank A, Bank B, and Bank C are members of Acme Bank. Accordingly, each bank has a settlement account and a collateral account. Non-Member Banks are the banks that take part in the settlement systems. The non-member banks do not have accounts at Acme Bank. But, they do have intermediaries that they go through. Each non-member bank has one or more intermediaries (in some embodiments, there is a 1:1 relationship as others tend to get more complex). For Settlement Utility, think of each member bank as having an account. In some embodiments, these accounts are mirror images of the collateral accounts. Funding and DeFunding refers to the act of moving money from the settlement account to the collateral account or vice versa.

In some embodiments, the described systems and methods ingest trades from all settlement members. The settlement members may be account members or non-account members. Non-account members typically go through an intermediary to settle their transactions. A member bank needs to approve the incoming payment requests from the bank on behalf of whom they are acting as an intermediary.

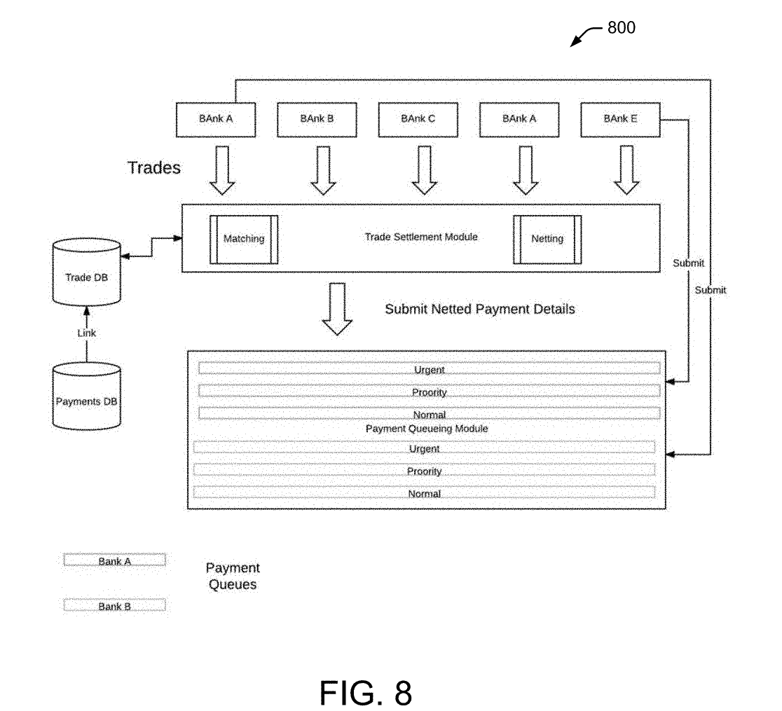

FIG. 8 illustrates an example environment 800 within which the described systems and methods may be implemented. In some embodiments, environment 800 uses a matching engine and a netting engine during various processing and settlement activities. For example, a particular trade may contain a settlement cycle in addition to a value date, which allows the described systems and methods to support multiple settlement cycles within a particular day.

In some embodiments, settlement cycles will occur at the top of the hour. Each party should be able to see the incoming and outgoing data associated with any transactions where it is a principal. If the party is a beneficiary, it should not be able to see the trade information. However, it should be able to see the settlement, as discussed herein.

In some embodiments, the described systems and methods support multiple types of payments based on the urgency of the settlements. For example, a particular implementation may have “Normal payments”, “Priority payments”, and “Urgent payments”. These different types of payments may be thought of as priority queues. These different types of payments are discussed in greater detail below.

The systems and methods described herein also support the ability for a specific payment to be split into multiple parts. For example, a payment should have an option that will allow it to be split up. The described systems and methods will call the smaller payments as payparts (partial payments). The ability to split up a payment will allow the systems and methods to leverage the liquidity savings mechanisms and give more liquidity efficiencies. Regardless of the number of payparts a payment is split into, the systems and methods will be able to link a payment to its payparts and a paypart to its parent payments.

The liquidity savings mechanism provides various benefits. For example, think of the payment component as a series of priority queues. As mentioned above, there are three types of payments—Normal, Priority, and Urgent. By default, payments will be optimized to give the participants the maximum liquidity efficiency. The urgent payment is slightly different because it needs to be paid out very quickly. In some embodiments, the described systems and methods will settle payments on the top of the hour. The systems and methods will set the urgent payments to be settled every minute. The urgent payments will have the option to bypass optimization.

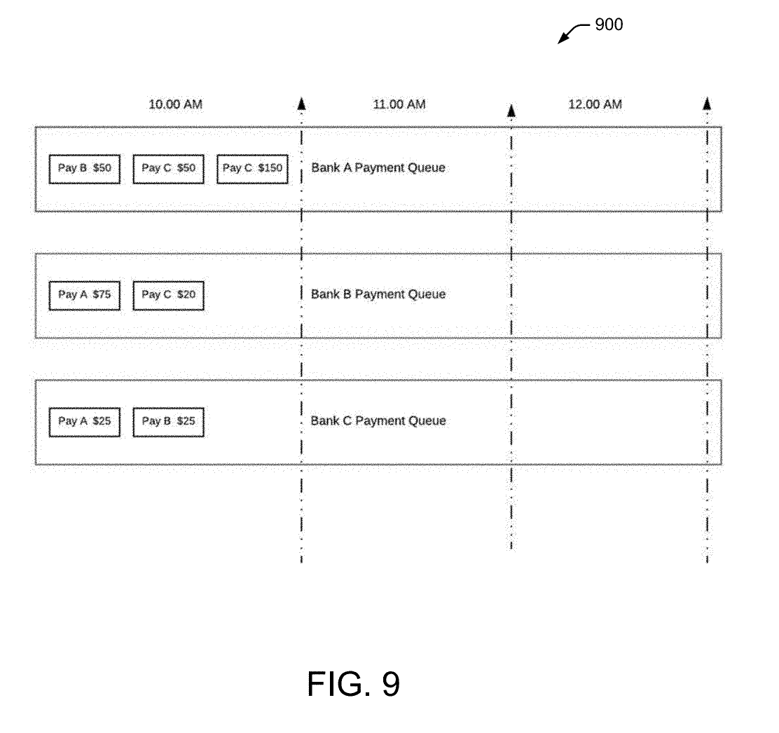

FIG. 9 illustrates example payment queues 900 showing the processing of various payments. In some embodiments, payment items within a settlement cycle are offset. In the example of FIG. 9, the systems and methods perform multiphase optimization, as discussed below.

The first phase is bilateral netting:

A−>B 50: B->A $75: Offset B->A: $25. Effect; DEBIT B: $25, CREDIT B: $25

A−>C$200, C−>A: $25: Offset A−>C: $175 Effect DEBIT A: $175, CREDIT C: $ 175

B−>C$20, C->B$25, Offset C−>B: $5 Effect DEBIT C: $5 CREDIT B: $5

Another phase is referred to as multilateral netting. In this case, we have B−>A and A−>C. The systems and methods will define this as a hop. A hop is the case when Node A−>Node B and Node B−>Node C. In this case, the systems and methods will be able to do further optimization and make the payment between either Node A <−?−>Node C. The systems and methods use the notation <−?−>to denote a payment that can be with either Node A−>Node C or Node C−>Node A. In some embodiments, the systems and methods are able to perform this in multiple phases until no more hops are determined. When there are no more hops that are possible, the systems and methods have reached an optimal point and the payments can be settled.

A priority payment is typically paid out in more than an hour. So, a payment marked as priority will need to make the next settlement cycle. A normal payment can be settled across multiple payment cycles. For example, a normal payment will need to be settled within the operating day. So, if there are 10 settled cycles, a normal payment can be paid across all of these cycles. Additionally, a normal payment can be offset against other priority payments. In some embodiments, this will provide the maximum liquidity savings.

The following payment terms are related to the systems and methods discussed herein.

Gross Amount Settled: This is the total gross amount settled (before netting)

Net Amount Settled: The sum of all the net amounts settled without LSM

Level 1 LSM: This is the amount (sum of all netted) that is settled with bilateral Offsets

Level 2 LSM: This is sum of all netted amount settled after multilateral offsets

The following time-bound metrics are related to the systems and methods discussed herein. In some embodiments, these time-bound metrics are for each bank and for each day.

PartSett1 TakeOff: Normal Queue PayPart Settlement Time: This is the time when at least a single paypart has been paid out for a payment that has been marked as “Normal”.

FullSett1 Land: This is the average time for a normal payment to be settled fully by PayParts.

An example implementation includes the parts discussed below.

1. Nodes and clearing groups, as discussed herein.

2. Workflows and dispute resolution may include any number of workflows, such as trade settlements and payment submissions.

3. Roles and payment approvals

4. Trade and payment ingestion

5. Settlement cycles and LSM

6. Manage payment disbursements

7. Data replications

8. Reports for various nodes and users

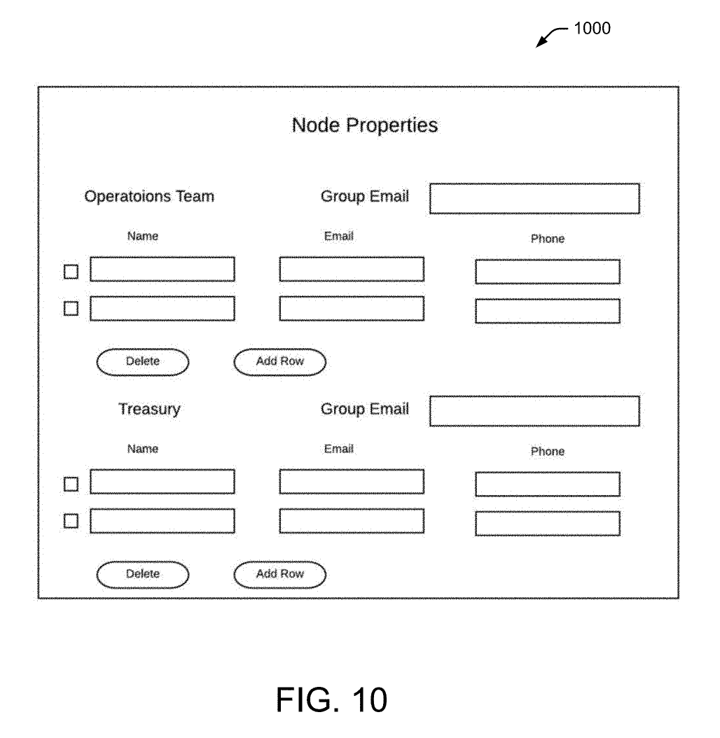

FIG. 10 illustrates an example 1000 of node properties. Each clearing group can add nodes and/or account numbers. In some embodiments, the financial management system discussed herein is the default settlement agent and Acme Bank is the default bank node. The described systems and methods leverage the trade data ingestion, the matcher, and the netting modules discussed herein. These systems and methods support settlement cycles, for example, by supporting an extra field (“settlement cycle”) in addition to the value date. This extra field is a number between 1 and 24 which identifies when the trades will be settled. The netting is performed between the trades that are a part of the same settlement cycle.

Payments can be a result of both workflows: trade settlements and/or payment submissions. The systems and methods can show the netted amount broken into individual trades and the gross amounts. This includes the ability for the operations team and treasury members to view the upcoming settlements.

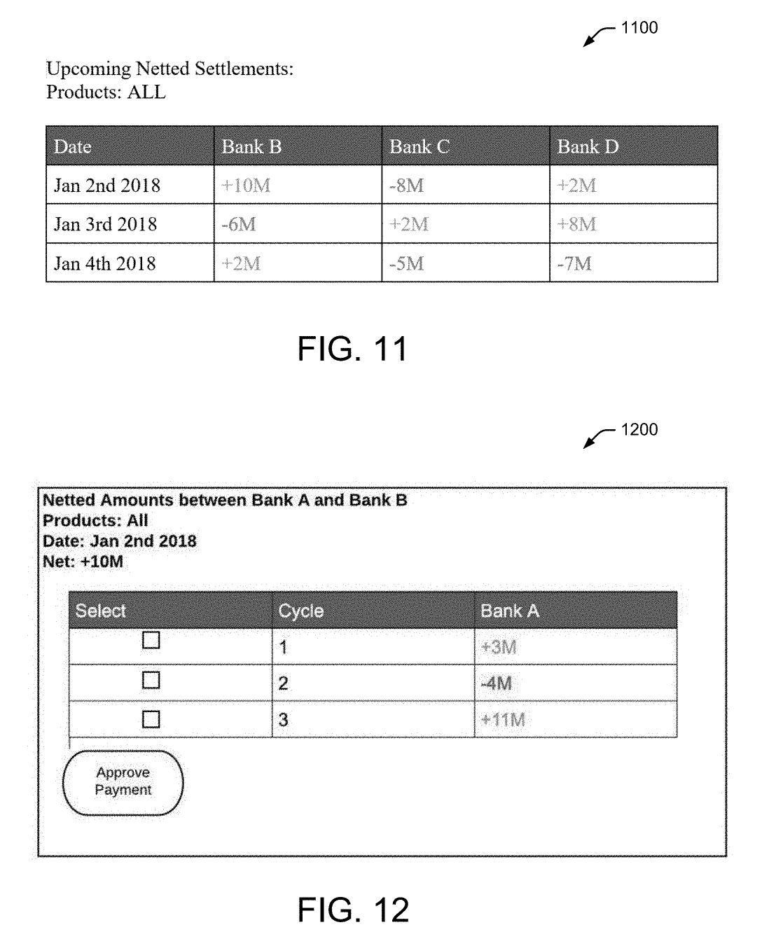

FIG. 11 illustrates an embodiment of a user interface display 1100 that presents upcoming settlements. In some embodiments, the data shown in user interface display 1100 are clickable hyperlinks that directs the user to the user interface display 1200 shown in FIG. 12. User interface display 1200 provides information to the user regarding all trades with a particular counterparty. In some embodiments, the data shown in user interface display 1200 are also clickable hyperlinks.

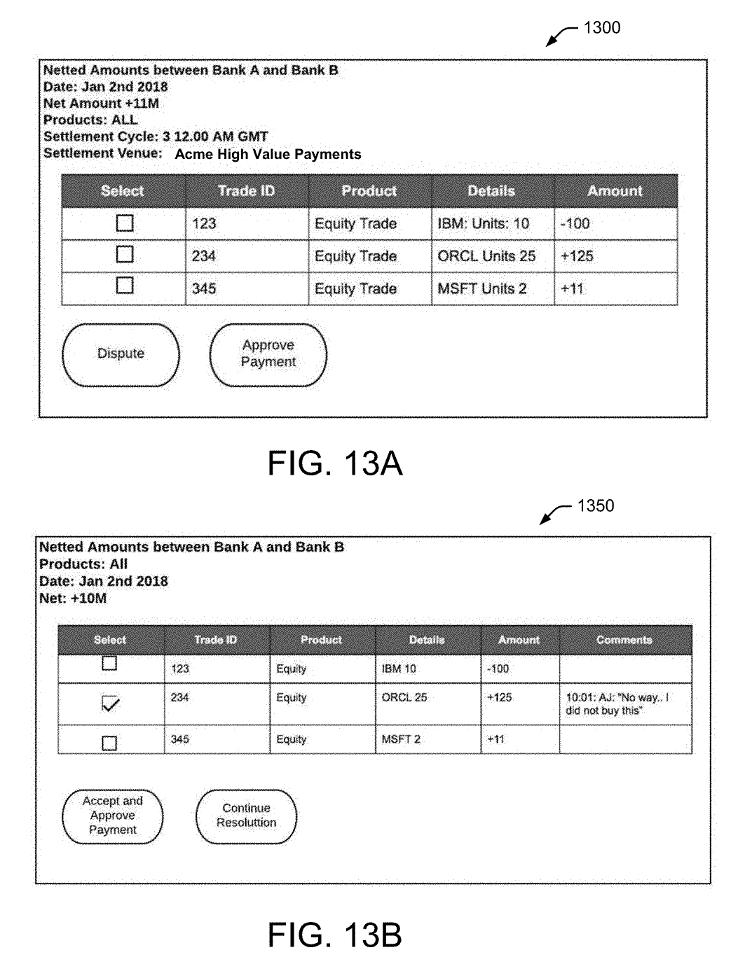

FIG. 13A illustrates an embodiment of a user interface display 1300 that presents all trades that are part of the settlement cycles. Based on user interface display 1300, the treasury team has the option to approve the netted amounts or view the breakdown of the net to gross payments. As shown in FIG. 13A, the user will be able to select one or more items to dispute. In some embodiments, the operations team member should enter a comment as to the reason for the dispute. The counterparty is then notified of the dispute and the operations team of the counterparty can then fix or send more details related to the discrepancy.

The resolution of the dispute will continue until both parties agree and the notes will continue to be aggregated. Based on actions of both parties, there are four actions that are possible, as noted below.

1. Accept the line item as is

2. Accept the line item with a change

3. Delete the line item

4. Delete the entire netted batch (e.g., if they are not able to resolve the dispute). In this situation, it is taken out of the system.

FIG. 13B illustrates an embodiment of a user interface display 1350 that presents trades between two banks (e.g., between two parties) and comments regarding one of the entries.

In some embodiments, each bank node will have the following roles.

Operations: The users will be able to view the trades in net and gross. Users are also responsible for the dispute resolution process defined above. However, payments are not typically settled until the treasury team approves it.

Treasury: The treasury team is ultimately responsible for the approval of the settlement. The team will not be able to dispute the trades, but will be able to approve one or more payments. In addition to the approval of the trades, the team will also need to do the following:

a. Funding

i. Set the minimum opening balance

ii. Fund the minimum balance

iii. Fund the supplemental balance

b. DeFunding

i. Request the defunding

c. Initiate a Payment : Send to a counterparty within the clearing group. If the bank requesting this payment is does not have an account, this will need to be approved by the treasury team of the beneficiary bank.

d. Approve Settlements

i. Trade Settlements: They will be able to approve one or more settlements. Each settlement can be for either a trade or for a payment request.

ii. Payment Settlement

iii. Approve payment request from a beneficiary

FIG. 14 illustrates an embodiment of a method 1400 for settling trades between multiple parties. Initially, a financial management system identifies 1402 multiple trades between multiple parties in a common network. As discussed herein, this common network may include any number of parties and may be organized by any entity, organization, individual, and the like. The financial management system identifies 1404 one or more settlement rules associated with the common network. Additionally, the financial management system displays 1406 the multiple trades to at least one of the parties. A user associated with the party to which the trades are displayed has an opportunity to approve or dispute each trade via a user interface.

The financial management system receives 1408 an approval or dispute associated with at least one of the displayed trades from at least one of the parties. After receiving the approval or dispute, the financial management system determines 1410 whether the received approval or dispute complies with the settlement rules associated with the common network. The financial management system implements 1412 the received approval or dispute if it complies with the settlement rules associated with the common network. Finally, the financial management system reports the approval or dispute of at least one trade to at least one party or other entity.

In some embodiments, the financial management system also monitors the multiple trades to be sure they comply with the settlement rules associated with the common network, regardless of whether any trade information is displayed to any of the parties.

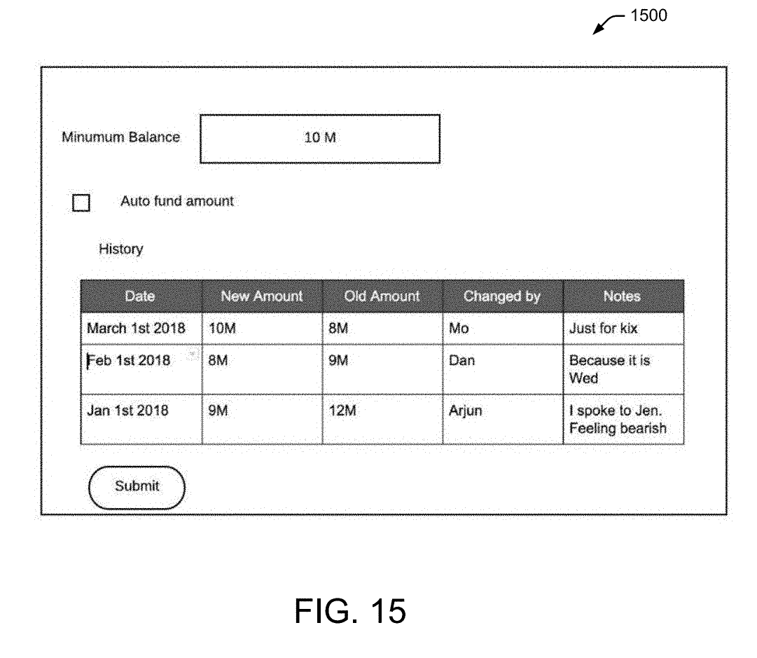

FIG. 15 illustrates an embodiment of a user interface display 1500 that presents the settings for all member banks.

Additional user interface displays may collect information relating to funding opening or supplemental balance. Other user interface displays allow users to request defunding and rebalancing of certain amounts, and creating payments (e.g., a payment to a counterpart). In other embodiments, an API may be used to create payments.

When a member of the treasury team logs in, the systems and methods described herein provide a new tab at the bottom called, for example, “Approve Settlements”. In particular, the treasury team member may be able to do the following:

1. Approve the trade settlements that have been submitted by the operations team. This approval can be done for payments that are up to 24 hours in advance.

2. Approve the incoming settlement requests where the bank is an intermediary. In some embodiments, the systems and methods described herein provide one or more collaboration mechanisms that allow the two parties to collaborate regarding approval or rejection of settlements.

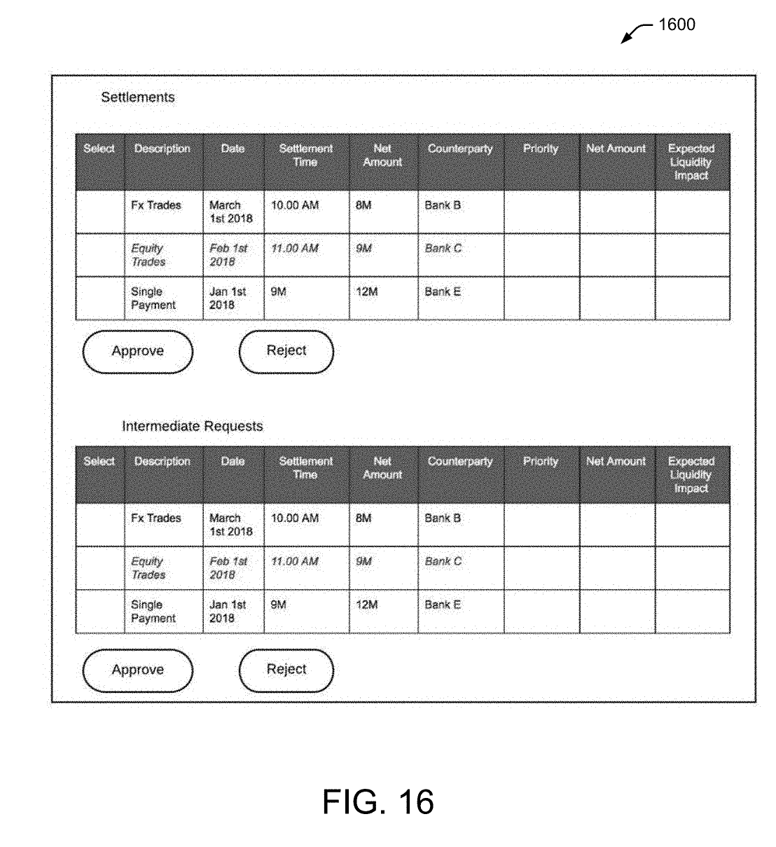

FIG. 16 illustrates an embodiment of a user interface display 1600 that presents various settlements available for approval or rejection by, for example, a treasury team.

Trade ingestion is handled in a manner similar to data ingestion (including fast data ingestion) and trade matching as discussed herein. The described systems and methods also use a netting engine as discussed above. In some embodiments, settlements are processed within one day. In particular implementations, the data ingestion systems and methods assume that the input is a trade. In other implementations, the data ingestion systems and methods can receive payment instructions and other types of data. For example, a payment instruction may support the payment metadata, such as information related to the payer, payee, beneficiary, priority, and the like.

LSM and offset cycles are discussed herein. When a payment is approved by the treasury team, it will be submitted to the settlement system. Then, depending on the priority, it will be added to the appropriate queue in the settlement system. This is where the offsetting will happen. As discussed herein, normal payments will often span across multiple settlement cycles. A priority payment on the other hand does not span settlement cycles.

One of the problems with any interbank large value settlement system is the lack of any visibility into incoming payments. If there is a way for the bank to see incoming payments, it will significantly reduce risk and improve treasury efficiency as the bank can better plan its liquidity supply and demand. In addition, if there is a way to collaborate between treasury teams, it can further increase efficiency by making them proactive in making payments rather than each department being receipt reactive. This is a very powerful feature of a shared ledger.

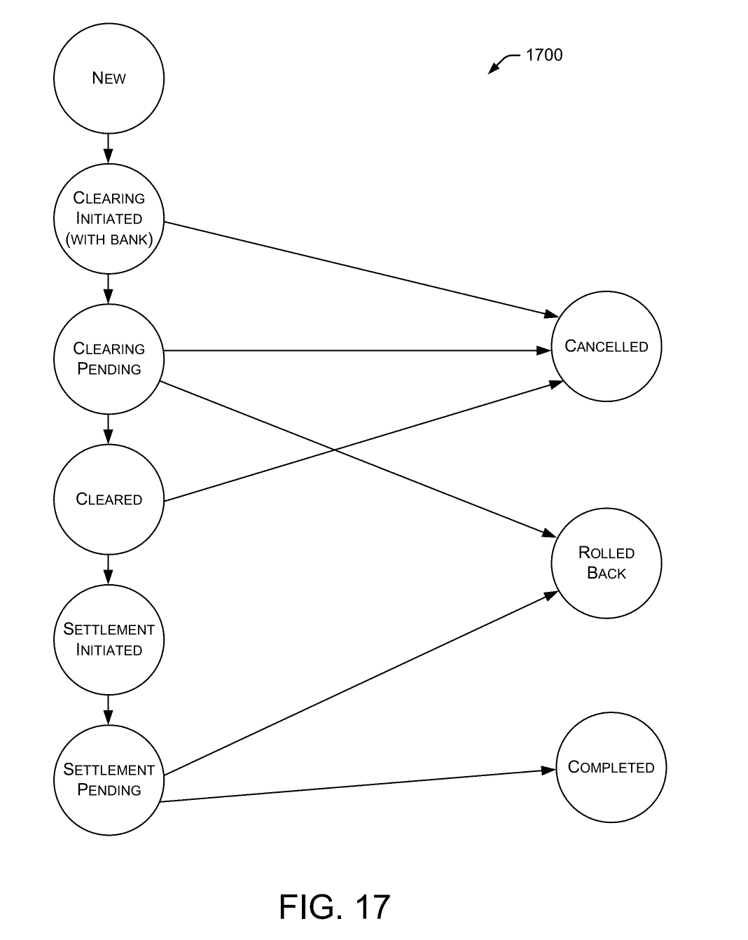

FIG. 17 illustrates an example state diagram 1700 showing various states that a transaction may pass through. As shown in FIG. 17, a particular transaction may be initiated (“new”), then clearing is initiated with a bank, after which the transaction's state is “clearing pending.” The next transaction state is “cleared”, then settlement is initiated, after which the transaction state is “settlement pending.” After the transaction has settled, the state becomes “completed.” As shown in state diagram 1700, the state diagram may branch to “cancelled” at locations in the state diagram. For example, a transaction may be cancelled due to insufficient funds, a mutual decision to reverse the transaction before settlement, a bank internal ledger failure, and the like. Additionally, the state diagram may branch to “rolled back” at multiple locations. For example, a transaction may be rolled back due to an unrecoverable error, a cancellation of the transaction, and the like.

Each transaction and the associated transaction states may have additional metadata. The shared ledger (e.g., ledger 118 in FIG. 1) man contain all the state information and state changes for a transaction. A separate record is maintained for each state of the transaction. The record is not updated or modified. In some embodiments, all transactions are final and irreversible. The metadata for the new transaction includes a reference to the erroneous transaction that needs to be reversed. The parties are informed of the request to reverse the erroneous transaction as part of a new transaction. The new transaction also goes through the state changes shown in FIG. 17. When the new transaction is completed, the metadata of the initial transaction is also updated.

In some embodiments, the transactions and the metadata recorded in the shared permissioned ledger contain information that are very sensitive and confidential to the businesses initiating the instructions. The systems and methods described herein maintain the security of this information by encrypting data for each participant using a symmetric key that is unique to the participant. In some embodiments, the keys also have a key rotation policy where the data for that node is rekeyed. The keys for each node are bifurcated and saved in a secure storage location with role-based access controls. In some embodiments, only a special service called a cryptographic service can access these keys at runtime to encrypt and decrypt the data.

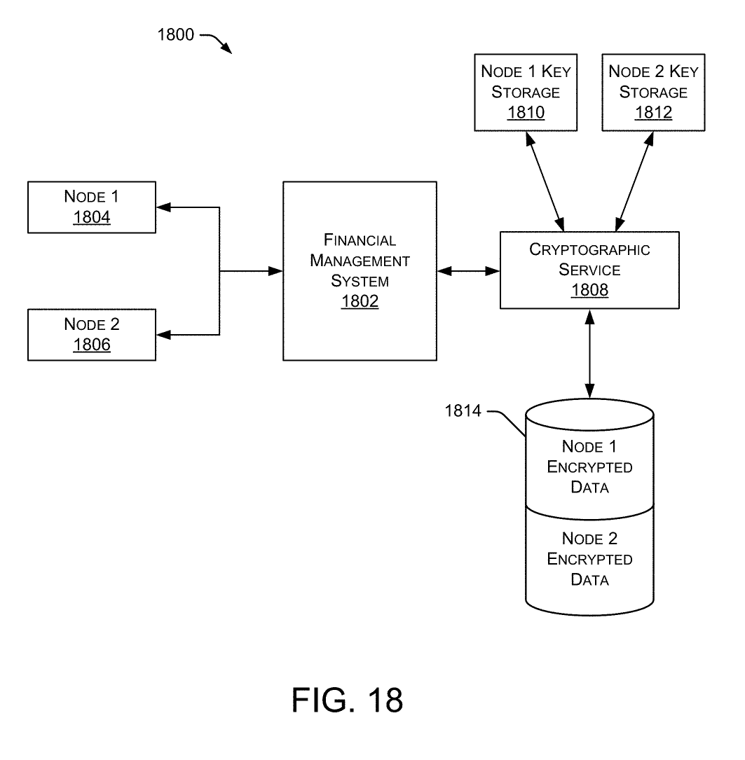

FIG. 18 is a block diagram illustrating an embodiment 1800 of a financial management system 1802 interacting with a cryptographic service 1808 and multiple client nodes 1804 and 1806. Although two client nodes 1804, 1806 are shown in FIG. 18, alternate embodiments may include any number of client nodes coupled to financial management system 1802. In the embodiment of FIG. 18, financial management system 1802 communicates with client nodes 1804, 1806 to manage one or more transactions between client nodes 1804 and 1806, or between one of client nodes 1804, 1806 and other client nodes, devices, or systems (not shown). Financial management system 1802 also communicates with cryptographic service 1808, which manages secure access to a data store 1814. In some embodiments, data store 1814 is a shared ledger (e.g., ledger 118 in FIG. 1) of the type discussed herein. In these embodiments, data store 1814 represents the capabilities of the shared ledger as they relate to data permissions.

As shown in FIG. 18, data store 1814 stores encrypted data associated with client nodes 1804 and 1806. In alternate embodiments, data store 1814 may store encrypted data associated with any number of client nodes. Cryptographic service 1808 ensures security of the data in data store 1814 using, for example, secure bifurcated keys that are stored in node 1 key storage 1810 and node 2 key storage 1812. Each key is unique for the associated client node. When financial management system 1802 wants to access data from data store 1814, the data access request must include an appropriate key to ensure that the data access request is authorized.

Each transaction can have two or more participants. In addition to the multiple parties involved in the transaction, there can be one or more “observers” to the transaction. The observer status is important from a compliance and governance standpoint. For example, the Federal Reserve or the CFTC is not a participant of the transaction, but may have observer rights on certain type of transactions in the system. In some embodiments the participants can subscribe to certain types of events. The transaction state in the state diagram above changes trigger events in the described systems.

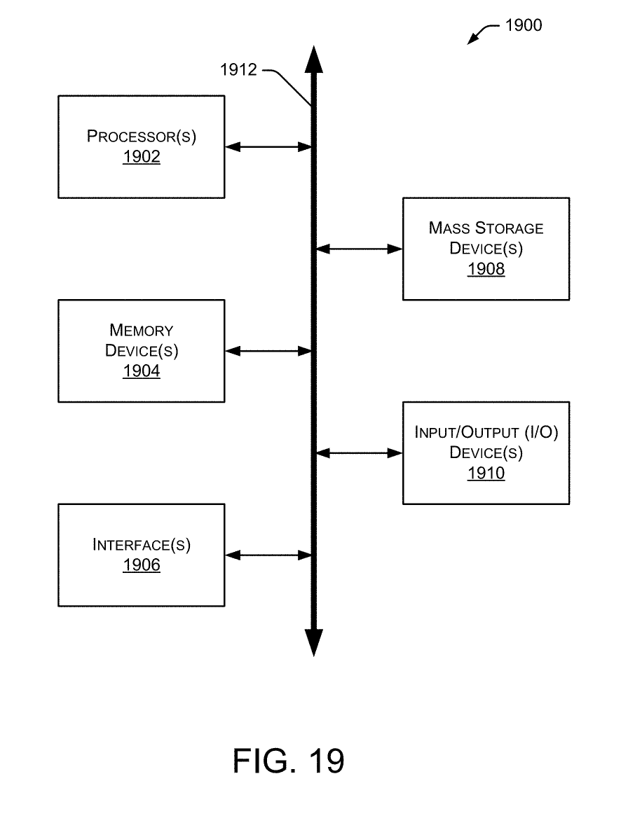

FIG. 19 is a block diagram illustrating an example computing device 1900. Computing device 1900 may be used to perform various procedures, such as those discussed herein. Computing device 1900 can function as a server, a client, a client node, a financial management system, or any other computing entity. Computing device 1900 can be any of a wide variety of computing devices, such as a workstation, a desktop computer, a notebook computer, a server computer, a handheld computer, a tablet, a smartphone, and the like. In some embodiments, computing device 1900 represents any of the computing devices discussed herein.

Computing device 1900 includes one or more processor(s) 1902, one or more memory device(s) 1904, one or more interface(s) 1906, one or more mass storage device(s) 1908, and one or more Input/Output (I/O) device(s) 1910, all of which are coupled to a bus 1912. Processor(s) 1902 include one or more processors or controllers that execute instructions stored in memory device(s) 1904 and/or mass storage device(s) 1908. Processor(s) 1902 may also include various types of computer-readable media, such as cache memory.

Memory device(s) 1904 include various computer-readable media, such as volatile memory (e.g., random access memory (RAM)) and/or nonvolatile memory (e.g., read-only memory (ROM)). Memory device(s) 1904 may also include rewritable ROM, such as Flash memory.

Mass storage device(s) 1908 include various computer readable media, such as magnetic tapes, magnetic disks, optical disks, solid state memory (e.g., Flash memory), and so forth. Various drives may also be included in mass storage device(s) 1908 to enable reading from and/or writing to the various computer readable media. Mass storage device(s) 1908 include removable media and/or non-removable media.

I/O device(s) 1910 include various devices that allow data and/or other information to be input to or retrieved from computing device 1900. Example I/O device(s) 1910 include cursor control devices, keyboards, keypads, microphones, monitors or other display devices, speakers, printers, network interface cards, modems, lenses, CCDs or other image capture devices, and the like.

Interface(s) 1906 include various interfaces that allow computing device 1900 to interact with other systems, devices, or computing environments. Example interface(s) 1906 include any number of different network interfaces, such as interfaces to local area networks (LANs), wide area networks (WANs), wireless networks, and the Internet.

Bus 1912 allows processor(s) 1902, memory device(s) 1904, interface(s) 1906, mass storage device(s) 1908, and I/O device(s) 1910 to communicate with one another, as well as other devices or components coupled to bus 1912. Bus 1912 represents one or more of several types of bus structures, such as a system bus, PCI bus, IEEE 1394 bus, USB bus, and so forth.

For purposes of illustration, programs and other executable program components are shown herein as discrete blocks, although it is understood that such programs and components may reside at various times in different storage components of computing device 1900, and are executed by processor(s) 1902. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

In the above disclosure, reference has been made to the accompanying drawings, which form a part hereof, and in which is shown by way of illustration specific implementations in which the disclosure may be practiced. It is understood that other implementations may be utilized, and structural changes may be made without departing from the scope of the present disclosure. References in the specification to “one embodiment,” “an embodiment,” “an example embodiment,” “selected embodiments,” “certain embodiments,” etc., indicate that the embodiment or embodiments described may include a particular feature, structure, or characteristic, but every embodiment may not necessarily include the particular feature, structure, or characteristic. Additionally, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Implementations of the systems, devices, and methods disclosed herein may comprise or utilize a special purpose or general-purpose computer including computer hardware, such as, for example, one or more processors and system memory, as discussed herein. Implementations within the scope of the present disclosure may also include physical and other computer-readable media for carrying or storing computer-executable instructions and/or data structures. Such computer-readable media can be any available media that may be accessed by a general purpose or special purpose computer system. Computer-readable media that store computer-executable instructions are computer storage media (devices). Computer-readable media that carry computer-executable instructions are transmission media. Thus, by way of example, and not limitation, implementations of the disclosure can include at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or a combination of hardwired and wireless) to a computer, the computer properly views the connection as a transmission medium. Transmissions media can include a network and/or data links, which can be used to carry desired program code means in the form of computer-executable instructions or data structures and which can be accessed by a general purpose or special purpose computer. Combinations of the above should also be included within the scope of computer-readable media.

Computer-executable instructions include, for example, instructions and data which, when executed at a processor, cause a general purpose computer, special purpose computer, or special purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Further, where appropriate, functions described herein can be performed in one or more of: hardware, software, firmware, digital components, or analog components. For example, one or more application specific integrated circuits (ASICs) can be programmed to carry out one or more of the systems and procedures described herein. Certain terms are used throughout the description and claims to refer to particular system components. As one skilled in the art will appreciate, components may be referred to by different names. This document does not intend to distinguish between components that differ in name, but not function.

It should be noted that the sensor embodiments discussed above may comprise computer hardware, software, firmware, or any combination thereof to perform at least a portion of their functions. For example, a module may include computer code configured to be executed in one or more processors, and may include hardware logic/electrical circuitry controlled by the computer code. These example devices are provided herein purposes of illustration, and are not intended to be limiting. Embodiments of the present disclosure may be implemented in further types of devices, as would be known to persons skilled in the relevant art(s).

At least some embodiments of the disclosure have been directed to computer program products comprising such logic (e.g., in the form of software) stored on any computer useable medium. Such software, when executed in one or more data processing devices, causes a device to operate as described herein.

While various embodiments of the present disclosure are described herein, it should be understood that they are presented by way of example only, and not limitation. It will be apparent to persons skilled in the relevant art that various changes in form and detail can be made therein without departing from the spirit and scope of the disclosure. Thus, the breadth and scope of the present disclosure should not be limited by any of the described exemplary embodiments, but should be defined only in accordance with the following claims and their equivalents. The description herein is presented for the purposes of illustration and description. It is not intended to be exhaustive or to limit the disclosure to the precise form disclosed. Many modifications and variations are possible in light of the disclosed teaching. Further, it should be noted that any or all of the alternate implementations discussed herein may be used in any combination desired to form additional hybrid implementations of the disclosure.

1. A method comprising:
identifying, by a financial management system, a plurality of trades between a plurality of parties in a common network;
identifying, by the financial management system, settlement rules associated with the common network;
displaying the plurality of trades to the plurality of parties;
receiving an approval or dispute associated with at least one of the plurality of trades from at least one party;
determining whether the received approval or dispute complies with the settlement rules associated with the common network; and
implementing the received approval or dispute if it complies with the settlement rules associated with the common network.

2. The method of claim 1, wherein the settlement rules associated with the common network are applied to each of the plurality of parties in the common network.

3. The method of claim 1, wherein the settlement rules associated with the common network include collateral levels required for different types of trades.

4. The method of claim 1, wherein the settlement rules associated with the common network define how trades are settled between the plurality of parties in the common network.

5. The method of claim 1, wherein the settlement rules associated with the common network define when and how frequently trades are settled between the plurality of parties in the common network.

6. The method of claim 1, wherein the settlement rules associated with the common network define thresholds associated with collateral levels required for each trade and timing of settlements associated with the plurality of trades.

7. The method of claim 1, wherein the plurality of trades are associated with a purchase or sale of securities.

8. The method of claim 1, further comprising reporting, by the financial management system, settlement of at least one of the plurality of trades to at least one of the plurality of parties in the common network.

9. The method of claim 1, further comprising identifying, by the financial management system, a plurality of partial trades associated with one of the plurality of trades.

10. The method of claim 9, wherein displaying the plurality of trades includes displaying the plurality of partial trades.

11. The method of claim 1, wherein each of the plurality of trades has an associated priority level.

12. The method of claim 11, wherein a time period for executing each of the plurality of trades is based on the priority level associated with the particular trade.

13. The method of claim 1, further comprising receiving, by the financial management system, comments associated with at least one party associated with a particular trade.

14. A method comprising:
identifying, by a financial management system, a trade between a plurality of parties in a common network;
identifying, by the financial management system, a plurality of partial trades associated with the identified trade;
identifying, by the financial management system, settlement rules associated with the common network;
displaying the plurality of partial trades to the plurality of parties;
receiving an approval or dispute associated with at least one of the partial trades from at least one party;
determining whether the received approval or dispute complies with the settlement rules associated with the common network; and
implementing the received approval or dispute if it complies with the settlement rules associated with the common network.

15. The method of claim 14, wherein the settlement rules associated with the common network are applied to each of the plurality of parties in the common network.

16. The method of claim 14, wherein the settlement rules associated with the common network include at least one of collateral levels required for different types of trades, when trades are settled, and how frequently trades are settled.

17. The method of claim 14, wherein the trade has an associated priority level, and wherein a time period for executing each of the partial trades is based on the priority level associated with the trade.

18. The method of claim 14, wherein the plurality of partial trades are associated with a purchase or sale of securities.

19. An apparatus comprising:
a data ingestion system configured to receive data associated with a plurality of trades between a plurality of parties in a common network; and
a financial management system coupled to the data ingestion system and configured to:
identify settlement rules associated with the common network;
display the plurality of trades to the plurality of parties;
receive an approval or dispute associated with at least one of the plurality of trades from at least one party;
determine whether the received approval or dispute complies with the settlement rules associated with the common network; and
implement the received approval or dispute if it complies with the settlement rules associated with the common network.

20. The apparatus of claim 19, wherein the settlement rules associated with the common network are applied to each of the plurality of parties in the common network.
